(19) United States
(12) Patent Application Publication
(10) Pub. No.: US 2026/0082324 A1
(43) Pub. Date: Mar. 19, 2026

(54) TRACKING REFERENCE SIGNALS FOR ENERGY SAVING MODES

(71) Applicant: QUALCOMM Incorporated, San Diego, CA (US)

(72) Inventors: Hung Dinh LY, San Diego, CA (US); Ahmed Attia ABOTABL, San Diego, CA (US); Kexin XIAO, Shanghai (CN)

(21) Appl. No.: 19/106,545

(22) PCT Filed: Oct. 28, 2022
(86) PCT No.: PCT/CN2022/128114

§ 371 Date: Feb. 25, 2025

(51) Int. Cl. H04W 52/02; H04B 7/06; H04L 5/00

(52) U.S. Cl. CPC H04W 52/0229; H04B 7/0626; H04L 5/0051

(57) ABSTRACT

Methods, systems, and devices for wireless communications are described. A user equipment (UE) may receive, while in a connected mode, a control message indicating whether the UE is to use channel state information (CSI) reference signals (CSI-RSs) as tracking reference signals (TRSs) when the UE operates in an idle more or an inactive mode. The UE may transition to the idle more or the inactive mode and may perform, while in the idle more or the inactive mode, automatic gain control (AGC), time/frequency tracking, or both, using the CSI-RSs as the TRSs based on the control message indicating that the UE is to use the CSI-RSs as the TRSs. In some examples, the UE may perform the AGC, time/frequency tracking, or both, based on one or more CSI-RS resource occasions associated with the CSI-RSs.

### CROSS REFERENCE

The present Application is a 371 national phase filing of International PCT Application No. PCT/CN2022/128114 by LY et al., entitled “TRACKING REFERENCE SIGNALS FOR ENERGY SAVING MODES,” filed Oct. 28, 2022, which is assigned to the assignee hereof, and which is expressly incorporated by reference in its entirety herein.

### FIELD OF TECHNOLOGY

The following relates to wireless communications, including tracking reference signals (TRSs) for energy saving modes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support tracking reference signals (TRSs) for energy saving modes. Generally, the techniques described herein may enable a user equipment (UE) to receive dynamic channel state information (CSI) reference signal (CSI-RS) transmit power updates to support use of one or more CSI-RSs as TRSs to perform certain functions, such as automatic gain control (AGC), time and frequency tracking (e.g., time/frequency tracking), or both, while operating in an idle mode or an inactive mode. For example, the UE may receive, while in a connected mode, a control message indicating whether the UE is to use CSI-RSs as TRSs when the UE operates in the idle mode or the inactive mode. Additionally, the UE may transition to the idle mode or the inactive mode and perform, while in the idle mode or the inactive mode, AGC, or time and frequency tracking, or both, using the CSI-RSs as the TRSs based on the control message indicating that the UE is to use the CSI-RSs as the TRSs.

In some examples, the UE may perform the AGC, or time and frequency tracking, or both, based on one or more CSI-RS resource occasions associated with the CSI-RSs. Additionally, or alternatively, the control message may indicate a first CSI-RS resource configuration for the one or more CSI-RS resource occasions, which may include one or more transmit power offsets between a CSI-RS transmit power and a synchronization signal block (SSB) transmit power. In such cases, the one or more transmit power offsets may include a respective transmit power offset for each CSI-RS resource occasion of the one or more CSI-RS resource occasions, thereby enabling the UE to determine a transmit power for CSI-RSs used as TRSs before transitioning to the idle or inactive mode. In some cases, a system information message may include an indication of an updated configuration of the one or more CSI-RS resource occasions. In other examples, a system information may indicate multiple configuration of the one or more CSI-RS resource occasions, and the control message may select one of the multiple configuration the UE may use for the AGC, or the time and frequency tracking, or both, while in the idle mode or the inactive mode.

A method for wireless communication at a UE is described. The method may include receiving, while in a connected mode, a control message indicating whether the UE is to use CSI-RSs for one or more functions, the one or more functions including using the CSI-RSs as TRSs when the UE operates in an idle mode or an inactive mode, transitioning to the idle mode or the inactive mode, and performing, while in the idle mode or the inactive mode, AGC or time/frequency tracking, or both, using the CSI-RSs as the TRSs based on the control message indicating that the UE is to use the CSI-RSs for the one or more functions including using the CSI-RSs as the TRSs.

An apparatus for wireless communication at a UE is described. The apparatus may include a processor, memory coupled with the processor, and instructions stored in the memory. The instructions may be executable by the processor to cause the apparatus to receive, while in a connected mode, a control message indicating whether the UE is to use CSI-RSs for one or more functions, the one or more functions including using the CSI-RSs as TRSs when the UE operates in an idle mode or an inactive mode, transition to the idle mode or the inactive mode, and perform, while in the idle mode or the inactive mode, AGC or time/frequency tracking, or both, using the CSI-RSs as the TRSs based on the control message indicating that the UE is to use the CSI-RSs for the one or more functions including using the CSI-RSs as the TRSs.

Another apparatus for wireless communication at a UE is described. The apparatus may include means for receiving, while in a connected mode, a control message indicating whether the UE is to use CSI-RSs for one or more functions, the one or more functions including using the CSI-RSs as TRSs when the UE operates in an idle mode or an inactive mode, means for transitioning to the idle mode or the inactive mode, and means for performing, while in the idle mode or the inactive mode, AGC or time/frequency tracking, or both, using the CSI-RSs as the TRSs based on the control message indicating that the UE is to use the CSI-RSs for the one or more functions including using the CSI-RSs as the TRSs.

A non-transitory computer-readable medium storing code for wireless communication at a UE is described. The code may include instructions executable by a processor to receive, while in a connected mode, a control message indicating whether the UE is to use CSI-RSs for one or more functions, the one or more functions including using the CSI-RSs as TRSs when the UE operates in an idle mode or an inactive mode, transition to the idle mode or the inactive mode, and perform, while in the idle mode or the inactive mode, AGC or time/frequency tracking, or both, using the CSI-RSs as the TRSs based on the control message indicating that the UE is to use the CSI-RSs for the one or more functions including using the CSI-RSs as the TRSs.

In some examples of the method, apparatuses, and non-transitory computer-readable medium described herein, performing the AGC or the time/frequency tracking, or both may include operations, features, means, or instructions for performing the AGC or the time/frequency tracking, or both, using the CSI-RSs in accordance with the control message and based on one or more CSI-RS resource occasions associated with the CSI-RSs.

In some examples of the method, apparatuses, and non-transitory computer-readable medium described herein, the control message further indicates a first CSI-RS resource configuration for the one or more CSI-RS resource occasions and the method, apparatuses, and non-transitory computer-readable medium may include further operations, features, means, or instructions for identifying one or more transmit power offsets between a CSI-RS transmit power and a SSB transmit power, the first CSI-RS resource configuration indicating the one or more transmit power offsets, where performing the AGC or the time/frequency tracking, or both, using the CSI-RSs may be based on the one or more transmit power offsets.

In some examples of the method, apparatuses, and non-transitory computer-readable medium described herein, the one or more transmit power offsets include a respective transmit power offset for each CSI-RS resource occasion of the one or more CSI-RS resource occasions.

Some examples of the method, apparatuses, and non-transitory computer-readable medium described herein may further include operations, features, means, or instructions for receiving a control signal for paging message reception indicating a CSI-RS resource configuration for one or more other CSI-RS resource occasions that override the one or more CSI-RS resource occasions and performing additional AGC or additional time/frequency tracking, or both, using the CSI-RSs based on the one or more other CSI-RS resource occasions.

In some examples of the method, apparatuses, and non-transitory computer-readable medium described herein, the control signal for paging message reception includes an EPI or paging DCI.

Some examples of the method, apparatuses, and non-transitory computer-readable medium described herein may further include operations, features, means, or instructions for receiving a system information message indicating a first CSI-RS resource configuration, the first CSI-RS resource configuration being different from a prior CSI-RS resource configuration received by the UE and indicating the one or more CSI-RS resource occasions, where performing the AGC or the time/frequency tracking, or both, using the CSI-RSs may be based on the first CSI-RS resource configuration.

In some examples of the method, apparatuses, and non-transitory computer-readable medium described herein, the system information message may be received before transitioning to the idle mode or the inactive mode and the system information message may be received after transitioning to the idle mode or the inactive mode.

Some examples of the method, apparatuses, and non-transitory computer-readable medium described herein may further include operations, features, means, or instructions for receiving a control signal for paging message reception indicating a second CSI-RS resource configuration for one or more other CSI-RS resource occasions that override the one or more CSI-RS resource occasions and performing additional AGC or additional time/frequency tracking, or both, using the CSI-RSs based on the one or more other CSI-RS resource occasions.

In some examples of the method, apparatuses, and non-transitory computer-readable medium described herein, the control signal for paging message reception includes an EPI or paging DCI.

Some examples of the method, apparatuses, and non-transitory computer-readable medium described herein may further include operations, features, means, or instructions for receiving a system information message indicating a set of multiple CSI-RS resource configurations, where performing the AGC or the time/frequency tracking, or both, using the CSI-RSs may be based on a first CSI-RS resource configuration of the set of multiple CSI-RS resource configurations, the first CSI-RS resource configuration indicating the one or more CSI-RS resource occasions.

In some examples of the method, apparatuses, and non-transitory computer-readable medium described herein, the control message further indicates the first CSI-RS resource configuration of the set of multiple CSI-RS resource configurations.

In some examples of the method, apparatuses, and non-transitory computer-readable medium described herein, the control message excludes an indication of a CSI-RS resource configuration of the set of multiple CSI-RS resource configurations, the first CSI-RS resource configuration including a default CSI-RS resource configuration.

Some examples of the method, apparatuses, and non-transitory computer-readable medium described herein may further include operations, features, means, or instructions for receiving a control signal for paging message reception indicating a second CSI-RS resource configuration of the set of multiple CSI-RS resource configurations, the second CSI-RS resource configuration being different from the first CSI-RS resource configuration and performing additional AGC or additional time/frequency tracking, or both, using the CSI-RSs based on the second CSI-RS resource configuration.

In some examples of the method, apparatuses, and non-transitory computer-readable medium described herein, the control signal for paging message reception includes an EPI or paging DCI.

Some examples of the method, apparatuses, and non-transitory computer-readable medium described herein may further include operations, features, means, or instructions for receiving a second control message indicating that the UE may be to exclude the CSI-RSs for the one or more functions including using the CSI-RSs as the TRSs, and where performing the AGC or the time/frequency tracking, or both, includes and performing the AGC or the time/frequency tracking, or both, using SSBs in accordance with the second control message.

Some examples of the method, apparatuses, and non-transitory computer-readable medium described herein may further include operations, features, means, or instructions for receiving, before transitioning to the idle mode or the inactive mode, a configuration of one or more functions that may be associated with dynamic adaptation of one or more communication parameters, where the AGC or the time/frequency tracking, or both, may be performed using the CSI-RSs based on the configuration of the one or more functions.

In some examples of the method, apparatuses, and non-transitory computer-readable medium described herein, the control message includes a RRC message or MAC-CE message.

A method for wireless communication at a network entity is described. The method may include communicating with a UE while the UE operates in a connected mode, transmitting, to the UE, a control message indicating whether the UE is to use CSI-RSs for one or more functions, the one or more functions including using the CSI-RSs as TRSs when the UE operates in an idle mode or an inactive mode, and transmitting the CSI-RSs while the UE is in the idle mode or the inactive mode, where the CSI-RSs are transmitted based on a dynamic adaptation of one or more communication parameters that modify a transmit power of the CSI-RSs.

An apparatus for wireless communication at a network entity is described. The apparatus may include a processor, memory coupled with the processor, and instructions stored in the memory. The instructions may be executable by the processor to cause the apparatus to communicate with a UE while the UE operates in a connected mode, transmit, to the UE, a control message indicating whether the UE is to use CSI-RSs for one or more functions, the one or more functions including using the CSI-RSs as TRSs when the UE operates in an idle mode or an inactive mode, and transmit the CSI-RSs while the UE is in the idle mode or the inactive mode, where the CSI-RSs are transmitted based on a dynamic adaptation of one or more communication parameters that modify a transmit power of the CSI-RSs.

Another apparatus for wireless communication at a network entity is described. The apparatus may include means for communicating with a UE while the UE operates in a connected mode, means for transmitting, to the UE, a control message indicating whether the UE is to use CSI-RSs for one or more functions, the one or more functions including using the CSI-RSs as TRSs when the UE operates in an idle mode or an inactive mode, and means for transmitting the CSI-RSs while the UE is in the idle mode or the inactive mode, where the CSI-RSs are transmitted based on a dynamic adaptation of one or more communication parameters that modify a transmit power of the CSI-RSs.

A non-transitory computer-readable medium storing code for wireless communication at a network entity is described. The code may include instructions executable by a processor to communicate with a UE while the UE operates in a connected mode, transmit, to the UE, a control message indicating whether the UE is to use CSI-RSs for one or more functions, the one or more functions including using the CSI-RSs as TRSs when the UE operates in an idle mode or an inactive mode, and transmit the CSI-RSs while the UE is in the idle mode or the inactive mode, where the CSI-RSs are transmitted based on a dynamic adaptation of one or more communication parameters that modify a transmit power of the CSI-RSs.

In some examples of the method, apparatuses, and non-transitory computer-readable medium described herein, transmitting the control message may include operations, features, means, or instructions for transmitting the control message including an indication that the UE may be to use the CSI-RSs for the one or more functions including using the CSI-RSs as the TRSs.

In some examples of the method, apparatuses, and non-transitory computer-readable medium described herein, the control message further indicates a first CSI-RS resource configuration for one or more CSI-RS resource occasions associated with the CSI-RSs, the first CSI-RS resource configuration indicating one or more transmit power offsets between a CSI-RS transmit power and a SSB transmit power and the one or more transmit power offsets include a respective transmit power offset for each CSI-RS resource occasion of the one or more CSI-RS resource occasions.

Some examples of the method, apparatuses, and non-transitory computer-readable medium described herein may further include operations, features, means, or instructions for transmitting a control signal for paging message reception indicating a second CSI-RS resource configuration for one or more other CSI-RS resource occasions that override the one or more CSI-RS resource occasions, where the control signal for paging message reception includes an EPI or paging DCI.

Some examples of the method, apparatuses, and non-transitory computer-readable medium described herein may further include operations, features, means, or instructions for transmitting a system information message indicating a first CSI-RS resource configuration for one or more CSI-RS resource occasions associated with the CSI-RSs, the first CSI-RS resource configuration being different from a prior CSI-RS resource configuration transmitted to the UE, where the system information message may be transmitted before the UE transitions to the idle mode or the inactive mode or after the UE transitions to the idle mode or the inactive mode.

Some examples of the method, apparatuses, and non-transitory computer-readable medium described herein may further include operations, features, means, or instructions for transmitting a control signal for paging message reception indicating a second CSI-RS resource configuration for one or more other CSI-RS resource occasions that override the one or more CSI-RS resource occasions, where the control signal for paging message reception includes an EPI or paging DCI.

Some examples of the method, apparatuses, and non-transitory computer-readable medium described herein may further include operations, features, means, or instructions for transmitting a system information message indicating a set of multiple CSI-RS resource configurations, where the control message indicates a first CSI-RS resource configuration of the set of multiple CSI-RS resource configurations, and where the first CSI-RS resource configuration may be for one or more CSI-RS resource occasions associated with the CSI-RSs.

Some examples of the method, apparatuses, and non-transitory computer-readable medium described herein may further include operations, features, means, or instructions for transmitting a control signal for paging message reception indicating a second CSI-RS resource configuration of the set of multiple CSI-RS resource configurations, the second CSI-RS resource configuration being different from the first CSI-RS resource configuration, where the control signal for paging message reception includes an EPI or paging DCI.

In some examples of the method, apparatuses, and non-transitory computer-readable medium described herein, transmitting the control message may include operations, features, means, or instructions for transmitting the control message including an indication that the UE may be to exclude the CSI-RSs as the TRSs.

Some examples of the method, apparatuses, and non-transitory computer-readable medium described herein may further include operations, features, means, or instructions for transmitting, before the UE transitions to the idle mode or the inactive mode, a configuration of one or more functions that may be associated with the dynamic adaptation of the one or more communication parameters, where transmitting the control message indicating whether the UE may be to use the CSI-RSs as the TRSs when the UE operates in an idle mode or an inactive mode may be based on the configuration of the one or more functions.

### BRIEF DESCRIPTION OF THE DRAWINGS

FIG. 1 illustrates an example of a wireless communications system that supports tracking reference signals (TRSs) for energy saving modes in accordance with one or more aspects of the present disclosure.

FIG. 2 illustrates an example of a wireless communications system that supports TRSs for energy saving modes in accordance with one or more aspects of the present disclosure.

FIG. 3 illustrates an example of a process flow that supports TRSs for energy saving modes in accordance with one or more aspects of the present disclosure.

FIGS. 4 and 5 illustrate block diagrams of devices that support TRSs for energy saving modes in accordance with one or more aspects of the present disclosure.

FIG. 6 illustrates a block diagram of a communications manager that supports TRSs for energy saving modes in accordance with one or more aspects of the present disclosure.

FIG. 7 illustrates a diagram of a system including a device that supports TRSs for energy saving modes in accordance with one or more aspects of the present disclosure.

FIGS. 8 and 9 illustrate block diagrams of devices that support TRSs for energy saving modes in accordance with one or more aspects of the present disclosure.

FIG. 10 illustrate a block diagram of a communications manager that supports TRSs for energy saving modes in accordance with one or more aspects of the present disclosure.

FIG. 11 illustrates a diagram of a system including a device that supports TRSs for energy saving modes in accordance with one or more aspects of the present disclosure.

FIGS. 12 through 16 illustrate flowcharts showing methods that support TRSs for energy saving modes in accordance with one or more aspects of the present disclosure.

### DETAILED DESCRIPTION

Some wireless communications systems may implement energy saving features to reduce power consumption while supporting expansion of cellular networks. For example, a network entity may reduce power consumption by performing dynamic transmit power adaptation, dynamic antenna port adaptation (e.g., resulting in dynamic changes to transmit power), or both, for some reference signals, such as channel state information (CSI) reference signals (CSI-RS). In some examples, a user equipment (UE) may use reference signals, which may include synchronization signal blocks (SSBs), tracking reference signals (TRSs), or both, to perform operations such as automatic gain control (AGC), time and frequency tracking (which may also be referred to as time/frequency tracking), or the like. In some aspects, CSI-RSs may be configured as a TRSs for use by a UE, and these CSI-RSs may also be subject to power saving techniques such as the dynamic transmit power adjustment, the dynamic antenna port adjustment, or both.

In some examples, a UE may reduce power consumption by operating in an idle mode or an inactive mode for some duration. In an active mode (e.g., connected mode), the UE may receive a dynamic update of the transmit power for reference signals (e.g., CSI-RSs, TRSs). Conversely, in the inactive or the idle mode, the UE may be unable to receive the dynamic update of the transmit power for the reference signals, for example, without receiving a control signal associated with receiving a paging message or other message that indicates the transmit power update. However, receiving the control signal associated with receiving the paging message for each transmit power update may impact network power, UE power, overhead, or any combination thereof. As such, the UE operating in an idle or inactive mode may be unable to receive dynamic transmit power updates for TRSs (e.g., CSI-RSs) associated with network energy saving schemes.

Accordingly, techniques described herein may enable a UE to receive dynamic CSI-RS transmit power updates for CSI-RSs (e.g., TRSs) used to perform some functions, such as AGC, time and frequency tracking, or both, while the UE is in an active mode or an inactive mode. For example, the UE, operating in an active mode, may receive control signaling indicating whether the UE is to use CSI-RSs as TRSs for one or more functions when the UE is in the idle mode or the inactive mode. That is, before transitioning to the idle or the inactive mode, the UE may receive an indication of whether CSI-RSs may be used for the one or more functions. Accordingly, the UE may transition to the idle mode or inactive mode and may perform AGC, time and frequency tracking, or both, based on the control signaling. In some cases, the control signaling may indicate for the UE to use CSI-RSs as TRSs when the UE transitions to the idle mode or inactive mode. In such cases, the UE may perform the AGC, the time and frequency tracking, or both, using the CSI-RSs and in accordance with a CSI-RS resource configuration. The UE may receive an indication of the CSI-RS resource configuration via control signaling in the active mode, via system information in the active mode, the idle mode, or the inactive mode, via a control signal for paging message reception in the idle mode or the inactive mode, or any combination thereof. Conversely, the control signaling may indicate that the UE exclude (e.g., not use) the CSI-RSs for performing AGC, time and frequency tracking, or both, such that the UE may perform the AGC, time and frequency tracking, or both, using other reference signals, such as synchronization signal blocks (SSBs).

Additionally, or alternatively, whether the UE uses the CSI-RS when in the idle mode or the inactive mode may be based on (e.g., inherently determined based on) whether the UE is configured with features (e.g., operations, applications, functionality, or the like) that are associated with the dynamic power adaptation schemes used by the network entity. In such cases, the UE may determine whether CSI-RSs may be used, for example, as TRSs for the AGC and/or time and frequency tracking, based on a configuration or operation of the UE.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to tracking reference signals for energy saving modes.

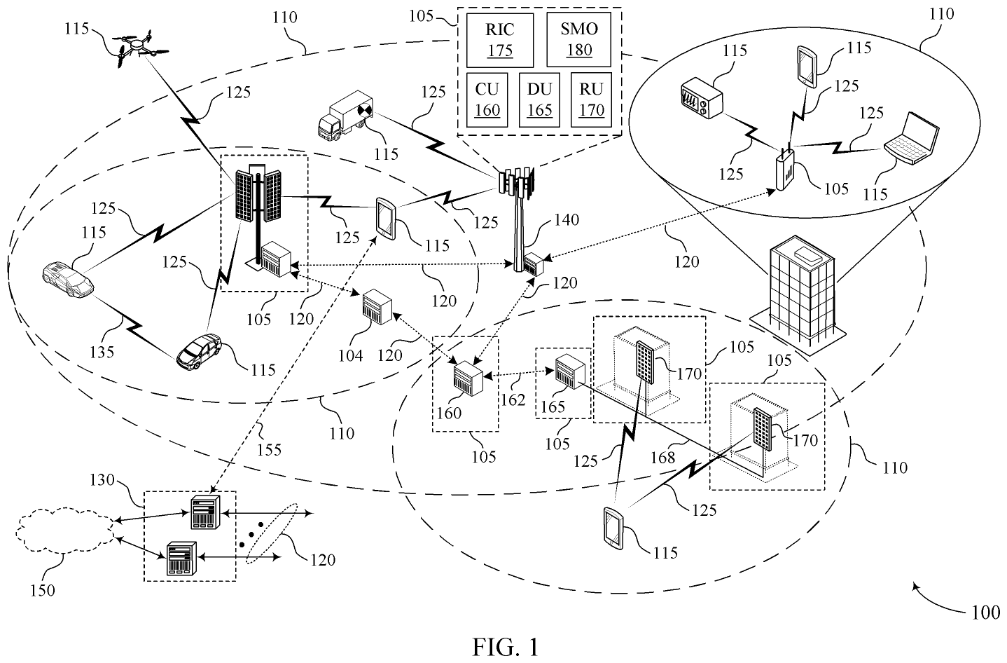

FIG. 1 illustrates an example of a wireless communications system 100 that supports TRSs for energy saving modes in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both, at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support TRSs for energy saving modes as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A UE 115 may operate in accordance with various states or modes for communicating with a network. As an example, a UE 115 may operate in an RRC idle state (e.g., RRC_IDLE), an RRC inactive state (e.g., RRC_INACTIVE), and/or an RRC connected state (e.g., RRC_CONNECTED). The UE 115 may transition between the various states or modes, for example, based on communications traffic for the UE 115. In the RRC idle state (which may be referred to as an idle mode), a UE 115 may not be registered to a particular cell, and may accordingly lack an access stratum (AS) context, and the UE 115 may thus not have an active RRC connection established with the network (e.g., via a network entity 105). In the idle mode, the UE 115 may wake up periodically to monitor channels for paging or other signaling, and the mobility of the UE 115 may be managed by the UE 115 when performing measurements of one or more cells. In the RRC connected state (which may be referred to as a connected mode or an active mode), the UE 115 may have an established RRC connection (e.g., with a 5GC) where the UE 115 may store an AS context. Here, the UE 115 may belong to a known cell and may be identified using, for example, a cell radio network temporary identifier (C-RNTI) assigned to the UE 115. When in the connected mode, the UE 115 may monitor for messages transmitted by the network, which may include monitoring various channels (e.g., paging channels, control channels, or the like).

The RRC inactive state (which may be referred to as an inactive mode) may be used to reduce signaling overhead and may provide an intermediate state (e.g., between idle and connected), and the inactive state may also be used to reduced latency when transitioning to another state (e.g., to the connected mode). The UE 115 may periodically wake up while in the inactive mode to monitor for control signals for paging message reception from the network, where the UE 115 may, in some cases, perform a random access procedure to move to the connected mode and communicate with the network.

The wireless communications system 100 may support dynamic indication of CSI-RS transmit power updates for a UE 115, which may support dynamically changing power parameters for TRSs (e.g., CSI-RSs) used to perform some functions, such as AGC, time and frequency tracking, or both, while the UE 115 is in an idle mode or an inactive mode. For example, the UE 115, while operating in an active mode, may receive control signaling indicating whether the UE 115 is to use CSI-RSs as TRSs for one or more functions that are to be performed when the UE 115 is in the idle mode or the inactive mode. Accordingly, the UE 115 may transition to the idle mode or inactive mode and may perform the AGC, the time and frequency tracking, or both, based on the control signaling. In some cases, the control signaling may indicate for the UE 115 to use CSI-RSs as TRSs when the UE 115 transitions to the idle mode or inactive mode. In such cases, the UE 115 may perform the AGC, the time and frequency tracking, or both, using the CSI-RSs in accordance with a CSI-RS resource configuration of one or more CSI-RS occasions. The UE 115 may receive an indication of the CSI-RS resource configuration via control signaling (e.g., RRC signaling, such as an RRC connection release message) when in the active mode, via system information (e.g., one or more system information blocks (SIBs)) when in the active mode, the idle mode, or the inactive mode, via a control signal for paging message reception when in the idle mode or the inactive mode, or any combination thereof. Conversely, the control signaling may indicate for the UE 115 to exclude the CSI-RSs for performing AGC, time and frequency tracking, or both, such that the UE 115 may perform the AGC, time and frequency tracking, or both, using some other reference signals (e.g., SSBs).

Additionally, or alternatively, whether the UE 115 uses the CSI-RS when in the idle mode or the inactive mode may be based on (e.g., inherently determined based on) whether the UE 115 is configured with features (e.g., operations, applications, functionality, or the like) that are associated with the dynamic power adaptation schemes used by the network entity 105. For instance, the UE 115 may receive a configuration of the one or more functions (e.g., associated with dynamic transmit power updates) prior to (e.g., before) transitioning to the idle mode or the inactive mode. In some cases, the one or more functions may include, but are not limited to, AGC, time and frequency tracking, or both. As such, the UE 115 may determine to use the CSI-RSs for the one or more functions based on the configuration. In other examples, the UE 115 may be configured with other features that are not associated with the dynamic transmit power adaptation schemes used by the network entity 105-a, and the UE 115 may use some other reference signals (such as SSBs, among other examples) when performing the one or more functions in the idle mode or the inactive mode.

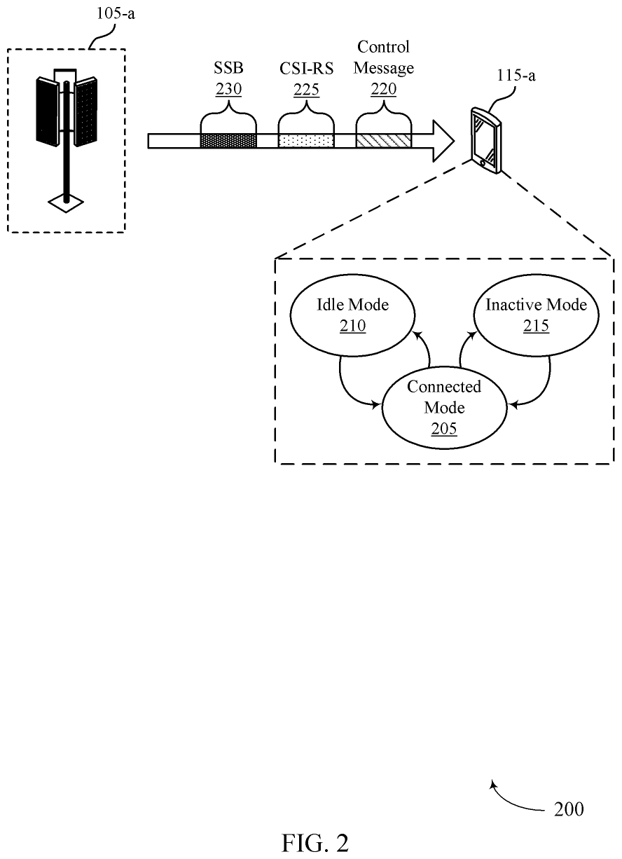

FIG. 2 illustrates an example of a wireless communications system 200 that supports TRSs for energy saving modes in accordance with one or more aspects of the present disclosure. In some examples, the wireless communications system 200 may implement or be implemented by aspects of the wireless communications system 100. For example, the wireless communications system 200 may include one or more network entities 105 (e.g., a network entity 105-a) and one or more UEs 115 (e.g., a UE 115-a), which may be examples of the corresponding devices as described with reference to FIG. 1. In the example of FIG. 2, the network entity 105-a may be examples of a CU 160, a DU 165, an RU 170, a base station 140, an IAB node 104, or one or more other network nodes as described with reference to FIG. 1. The wireless communications system 200 may include features to enable the UE 115-a to use dynamic CSI-RS transmit power updates for CSI-RSs when performing certain functions, such as AGC, time and frequency tracking, or both, when operating in an idle mode 210 or an inactive mode 215.

The wireless communications system 200 may utilize energy saving schemes to reduce power consumption (e.g., power consumption associated with a particular RAN and associated technologies) while supporting expansion of cellular networks. For example, a network entity 105, such as the network entity 105-a, may reduce power consumption by performing dynamic transmit power adaptation, dynamic antenna port adaptation (e.g., resulting in dynamic changes to transmit power), or both. The network entity 105-a may perform dynamic transmit power adaptation by dynamically updating (e.g., changing) a transmit power for some reference signals, such as CSI-RSs 225. Additionally, or alternatively, the network entity 105-a may perform dynamic antenna port adaptation by dynamically turning off antenna ports at the network entity 105-a, thereby dynamically changing a transmit power for reference signals, such as the CSI-RSs 225 (e.g., allowing power amplifiers at the network entity 105-a to operate in a more efficient energy mode). In either case, the network entity 105-a may dynamically indicate (e.g., via a control message 220), to the UE 115-a, operating in a connected mode 205, the dynamic update or dynamic change of the transmit power for the reference signals.

In some examples, a UE 115, such as the UE 115-a, may use reference signals, which may include SSBs 230, TRSs, or both, to perform functions (e.g., operations) such as AGC, time and frequency tracking (e.g., time tracking, frequency tracking, or both), or the like. In some examples (e.g., TRS is used to perform the functions), the UE 115-a may receive, from the network entity 105-a, a control message 220 (e.g., RRC signaling) indicating a transmit power for (e.g., associated with) the reference signals. Additionally, or alternatively, CSI-RSs 225 may be configured as TRSs. That is, the UE 115-a may perform AGC, time and frequency tracking, or both, using CSI-RSs 225, and the CSI-RSs 225 may accordingly be subject to power saving techniques such as dynamic transmit power adjustment, dynamic antenna port adjustment, or both.

In some examples, the UE 115-a may reduce power consumption by operating in the idle mode 210 or the inactive mode 215 for some durations. In such cases, the UE 115-a may perform the functions, such as the AGC, the time and frequency tracking, or both, using SSBs 230. Additionally, or alternatively, the network entity 105-a may configure (e.g., transmit a control message 220 configuring) the UE 115-a with CSI-RSs 225 for the AGC, the time and frequency tracking, or both (e.g., configure the CSI-RSs 225 as TRSs). That is, CSI-RS occasions for UEs 115 operating in the connected mode 205 may be shared with UEs 115 operating in the idle mode 210 or the inactive mode 215. Here, the UE 115-a may support periodic CSI-RS configurations in the idle mode 210 or the inactive mode 215. Additionally, CSI-RS utilization by a UE 115 in the idle mode 210 or the inactive mode 215 may not be limited to TRS (e.g., trs-info may not be provided in the CSI-RS configurations), and other functions may be performed by such a UE 115 using the CSI-RSs when in the idle mode 210 or the inactive mode 215.

In the connected mode 205 (e.g., active mode), the UE 115-a may receive a dynamic update of a transmit power for CSI-RSs 225. However, in the idle mode 210 or the inactive mode 215, the UE 115-a may be unable to receive the dynamic update of the transmit power for the CSI-RSs 225, for example, without additional signaling provided to the UE 115-a, which may result in increased overhead and further affect power consumption at the UE 115-a and/or the network entity 105-a. In particular, the UE 115-a may receive, when in an idle mode 210 or an inactive mode 215, a system information message (e.g., system information block (SIB)) indicating a configuration of CSI-RS occasions (e.g., TRS occasions). Additionally, the UE 115-a may receive a control signal for paging message reception (e.g., paging downlink control information (DCI) or early paging indication (EPI) (e.g., an advance notification of a paging occasion)) or other message (e.g., while operating in an idle mode 210 or an inactive mode 215) indicating a transmit power update associated with a CSI-RS occasion (e.g., indicating a CSI-RS occasion availability). The network entity 105-a, however, may transmit (e.g., only transmit) a paging DCI or EPI (e.g., the control signal for paging message reception) when a message (e.g., the paging message) is intended for the UE 115-a. That is, the network entity 105-a may only transmit an indication of a transmit power update when a control signal for paging message reception is intended (e.g., scheduled) for the UE 115-a. Thus, the indication of the transmit power update via control signaling associated with paging messages may not be dynamic (e.g., may not align with paging occasions or occasions when the control signaling associated with the paging messages are sent). Additionally, or alternatively, receiving a control signal for paging message reception for each transmit power update may impact network power, overhead, or both. Further, the UE 115-a may monitor for the control signal for the paging message reception according to monitoring occasions which may not align with occasions in which transmit power updates occur (e.g., occasions where connected mode UEs 115 receive a transmit power update). As such, the UE 115-a, operating in an idle mode 210 or an inactive mode 215 (e.g., an idle mode or inactive mode UE 115-a), may be unable to receive dynamic transmit power updates for TRSs (e.g., CSI-RSs) while the network implements energy saving schemes (e.g., for CSI-RSs).

Accordingly, techniques described herein may enable the UE 115-a to receive dynamic transmit power updates for the CSI-RSs 225 (e.g., TRSs) to perform some functions, such as AGC, time and frequency tracking, or both, when the UE 115-a is in the idle mode 210 or the inactive mode 215. As an example, the network entity 105-a may transmit, to the UE 115-a, a control message 220 (e.g., RRC message, RRC connection release message, MAC-CE) including an indication of whether the UE 115-a is to use CSI-RSs 225 (e.g., as TRS) for one or more functions when the UE 115-a operates in the idle mode 210 or the inactive mode 215. For example, the control message 220 may indicate for the UE 115-a to use CSI-RSs 225 (e.g., as TRS) for the AGC, the time and frequency tracking, or both, such that the UE 115-a may transition to the idle mode 210 or the inactive mode 215 and perform the AGC, the time and frequency tracking, or both, using the CSI-RSs 225 associated with one or more CSI-RS resource occasions. Conversely, the control message 220 may indicate for the UE 115-a to exclude (e.g., not use) the CSI-RS 225 (e.g., as TRS) for AGC, time and frequency tracking, or both, such that the UE 115-a may transition to the idle mode 210 or the inactive mode 215 and perform the AGC, the time and frequency tracking, or both, using other reference signal, such as SSBs 230.

Additionally, or alternatively, the UE 115-a may determine whether to use CSI-RSs 225 as TRS for the one or more functions when the UE 115-a operates in an idle mode 210 or an inactive mode 215 based on a configuration of the UE 115-a in the connected mode 205. In such, cases, the UE 115-a may receive a configuration of the one or more functions (e.g., associated with dynamic transmit power updates) prior to (e.g., before) transmission to the idle mode 210 or the inactive mode 215. In some cases, the one or more functions may include, but are not limited to, AGC, time and frequency tracking, or both. In any case, the UE 115-a may determine to exclude (e.g., not use) CSI-RS 225 for the AGC, the time and frequency tracking, or both, in the idle mode 210 or the inactive mode 215 based on the UE 115-a being configured, in the connected mode 205, with features that are not associated with dynamic transmit power updates, such as dynamic antenna port adaptation, dynamic transmit power adaptation, or both. Conversely, the UE 115-a may determine to use the CSI-RS 225 for the AGC, the time and frequency tracking, or both, in the idle mode 210 or the inactive mode 215 based on the UE 115-a being configured with features associated with dynamic transmit power updates, such as dynamic antenna port adaptation, dynamic transmit power adaptation, or both.

In some examples, such as when the UE 115-a uses CSI-RSs 225 for the AGC, the time and frequency tracking, or both, in the idle mode 210 or the inactive mode 215, the UE 115-a may receive an indication of a first CSI-RS resource configuration (e.g., CSI-RS resource occasion configurations) associated with the one or more resource occasions further associated with the CSI-RSs 225. The first CSI-RS resource configuration may indicate one or more transmit power offsets between a transmit power associated with CSI-RSs 225 and a transmit power associated with SSBs 230 for CSI-RS resources (e.g., one transmit power offset for each CSI-RS resource).

That is, the first CSI-RS resource configuration may indicate a respective transmit power offset for each CSI-RS resource occasion of the one or more resource occasions associated with the CSI-RSs 225.

In some cases, the control message 220 may include the indication of the first CSI-RS resource configuration. That is, the UE 115-a, operating in the connected mode 205, may receive the control message 220 indicating the first CSI-RS configuration, such that the UE 115-a performs the AGC, the time and frequency tracking, or both, using CSI-RSs 225 based on the one or more transmit power offsets indicated via the first CSI-RS resource configuration (e.g., further indicated via the control message 220).

Additionally, or alternatively, the UE 115-a, may receive a system information message (e.g., SIB) indicating a second (e.g., updated) CSI-RS resource configuration. That is, the system information message may indicate a second CSI-RS resource configuration that is different from a prior CSI-RS resource configuration received by the UE 115-a, such as the first CSI-RS resource configuration. In some cases, the UE 115-a may receive the system information message while in the connected mode 205 and prior to (e.g., before) the UE 115-a transitions to the idle mode 210 or the inactive mode 215. In some other cases, the UE 115-a may receive the system information message after (e.g., following) the UE 115-a transitions to the idle mode 210 or the inactive mode 215.

In some examples, the UE 115-a may receive (e.g., in the connected mode 205) a system information message indicating a set of CSI-RS resource configurations (e.g., multiple CSI-RS resource configurations), which may include at least the first CSI-RS resource configuration and the second CSI-RS resource configuration. In such case, the UE 115-a may receive (e.g., via the control message 220) an indication of a CSI-RS resource configuration, such as a third CSI-RS resource configuration, from the set of CSI-RS resource configurations. The indication of the third CSI-RS resource configuration may be an indication of an index corresponding to the third CSI-RS resource configuration of the set of CSI-RS resource configurations.

In some examples, the control message 220 may exclude an indication of a CSI-RS resource configuration (e.g., the indication of the third CSI-RS resource configuration) that is selected from the set of CSI-RS resource configurations. As such, the UE 115-a may use a default CSI-RS resource configuration from the set of CSI-RS resource configurations (e.g., which may result in relatively reduced overhead and/or latency as compared to the control message 220 indicating the first CSI-RS resource configuration and the SIB indicating the second CSI-RS resource configuration).

The UE 115-a may receive a control signal (e.g., paging DCI or EPI) for paging message reception indicating a CSI-RS resource configuration for one or more other CSI-RS resource occasions that overrides a previous CSI-RS resource configuration. That is, the UE 115-a may receive a control signal for paging message reception indicating a fourth CSI-RS resource configuration that overrides a previous CSI-RS resource configuration (e.g., the first CSI-RS resource configuration, the second CSI-RS resource configuration, or the third CSI-RS resource configuration from the set of CSI-RS resource configurations). In some examples (e.g., if the control signal for paging message reception overrides the third CSI-RS resource configuration), the control signal for paging message reception may include an indication of an index corresponding to the fourth CSI-RS resource configuration.

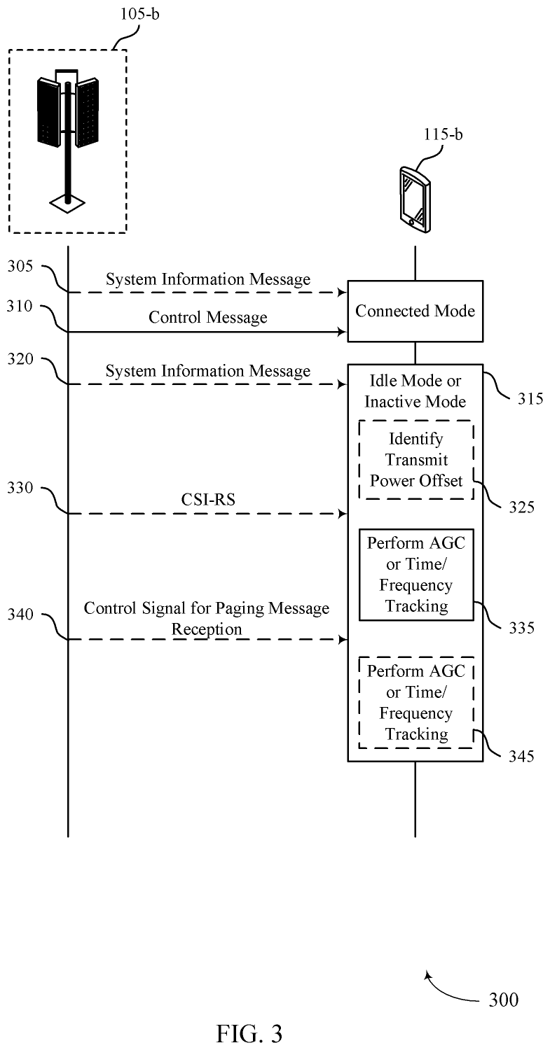

FIG. 3 illustrates an example of a process flow 300 that supports TRSs for energy saving modes in accordance with one or more aspects of the present disclosure. In some examples, the process flow 300 may implement or be implemented by aspects of the wireless communications system 100 and the wireless communications system 200. For example, the process flow 300 may include one or more network entities 105 (e.g., a network entity 105-b) and one or more UEs 115 (e.g., a UE 11-b), which may be examples of the corresponding devices as described with reference to FIG. 1. In the example of FIG. 3, the network entity 105-b may be examples of a CU 160, a DU 165, an RU 170, a base station 140, an IAB node 104, or one or more other network nodes as described with reference to FIG. 1. The process flow 300 may include features to enable the UE 115-b, operating in an idle mode or an inactive mode, to receive dynamic transmit power updates to support use of TRSs (e.g., CSI-RSs) to perform certain functions, such as AGC, time and frequency tracking, or both, thus contributing to network energy savings.

In some cases, at 305, the UE 115-b may receive a first system information message (e.g., a SIB) indicating a set of CSI-RS resource configurations.

At 310, the UE 115-b may receive, while in a connected mode, a control message indicating whether the UE 115-b is to use CSI-RSs for one or more functions, the one or more functions including using the CSI-RSs as tracking reference signals when the UE 115-b operates in an idle mode or an inactive mode. In some examples, the control message may indicate a first CSI-RS resource configuration for one or more CSI-RS resource occasions associated with the CSI-RSs. Additionally, or alternatively, the control message may indicate a first CSI-RS resource configuration of the set of CSI-RS resource configurations. Alternatively, the control message may exclude an indication of a CSI-RS resource configuration of the set of CSI-RS resource configurations.

In some examples, the UE 115-b may receive (e.g., via the control message), before transitioning to the idle mode or the inactive mode, a configuration of one or more functions that are associated with dynamic adaptation of one or more communication parameters. Additionally, or alternatively, the control message may include an RRC message (e.g., RRC connection release message) or a MAC-CE message.

At 315, the UE 115-b may transition to the idle mode or the inactive mode.

In some cases, at 320, the UE 115-b may optionally receive a second system information message indicating a second CSI-RS resource configuration, the second CSI-RS resource configuration being different from a prior CSI-RS resource configuration received by the UE 115-b. The second CSI-RS resource configuration may indicate the one or more CSI-RS resource occasions. The UE 115-b may receive the second system information message after transitioning to the idle mode or the inactive mode. In some other examples (e.g., not depicted in the process flow 300), the UE 115-b may receive the second system information message before (e.g., prior to) transitioning to the idle mode or the inactive mode.

In some cases, at 325, the UE 115-b may identify one or more transmit power offsets between a CSI-RS transmit power and an SSB transmit power, the one or more transmit power offsets being indicated via a CSI-RS resource configuration (e.g., the first CSI-RS resource configuration, the second CSI-RS resource configuration). In such cases, the one or more transmit power offsets may include a respective transmit power offset for each CSI-RS resource occasion of the one or more CSI-RS resource occasions.

In some cases, at 330, the UE 115-b may receive the CSI-RSs associated with the one or more CSI-RS resource occasions.

At 335, the UE 115-b may perform, while in the idle mode or the inactive mode, one or more functions, such as AGC, time and frequency tracking, or both, using the CSI-RSs as the TRSs based on the control message indicating that the UE 115-b is to use the CSI-RSs for the one or more functions including using the CSI-RSs (e.g., as the TRSs). In some examples, the UE 115-b may perform the AGC, the time and frequency tracking, or both, based on the one or more CSI-RS resource occasions associated with the CSI-RSs, based on the one or more transmit power offsets, a CSI-RS resource configuration (e.g., the first CSI-RS resource configuration, the second CSI-RS resource configuration,), or any combination thereof. Additionally, or alternatively, the UE 115-b may perform the AGC, the time and frequency tracking, or both, based on a default CSI-RS resource configuration (e.g., when the control message may exclude an indication of a CSI-RS resource configuration of the set of CSI-RS resource configurations).

In some cases, at 340, the UE 115-b may receive a control signal for paging message reception indicating a second CSI-RS resource configuration for one or more other CSI-RS resource occasions that override the one or more CSI-RS resource occasions. The control signal for paging message reception may include a EPI or a paging DCI.

In some cases, at 345, the UE 115-b may perform additional AGC, additional time and frequency tracking, or both, using the CSI-RSs. In some examples, the UE 115-b may perform the additional AGC, additional time and frequency tracking, or both, based on the one or more other CSI-RS resource occasions associated with the second CSI-RS resource configuration.

In some examples (e.g., not depicted in the process flow 300), the UE 115-b may receive a second control message indicating that the UE 115-b is to exclude the CSI-RSs for the one or more functions including using the CSI-RSs as the tracking reference signals. In such cases, the UE 115-b may perform, while in the idle mode or the inactive mode, additional functions, such as AGC, time and frequency tracking, or both, using SSBs in accordance with the second control message.

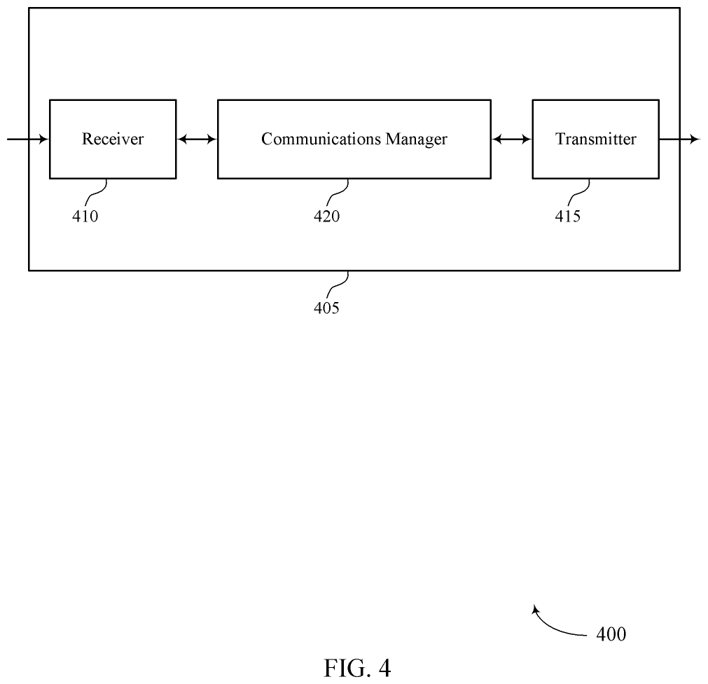

FIG. 4 shows a block diagram 400 of a device 405 that supports TRSs for energy saving modes in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to TRSs for energy saving modes). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to TRSs for energy saving modes). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of TRSs for energy saving modes as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a UE in accordance with examples as disclosed herein. For example, the communications manager 420 may be configured as or otherwise support a means for receiving, while in a connected mode, a control message indicating whether the UE is to use CSI-RSs for one or more functions, the one or more functions including using the CSI-RSs as TRSs when the UE operates in an idle mode or an inactive mode. The communications manager 420 may be configured as or otherwise support a means for transitioning to the idle mode or the inactive mode. The communications manager 420 may be configured as or otherwise support a means for performing, while in the idle mode or the inactive mode, AGC or time/frequency tracking, or both, using the CSI-RSs as the TRSs based on the control message indicating that the UE is to use the CSI-RSs for the one or more functions including using the CSI-RSs as the TRSs.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for TRSs for energy saving modes which may result in reduced processing, reduced power consumption, and more efficient utilization of communication resources, among other advantages.

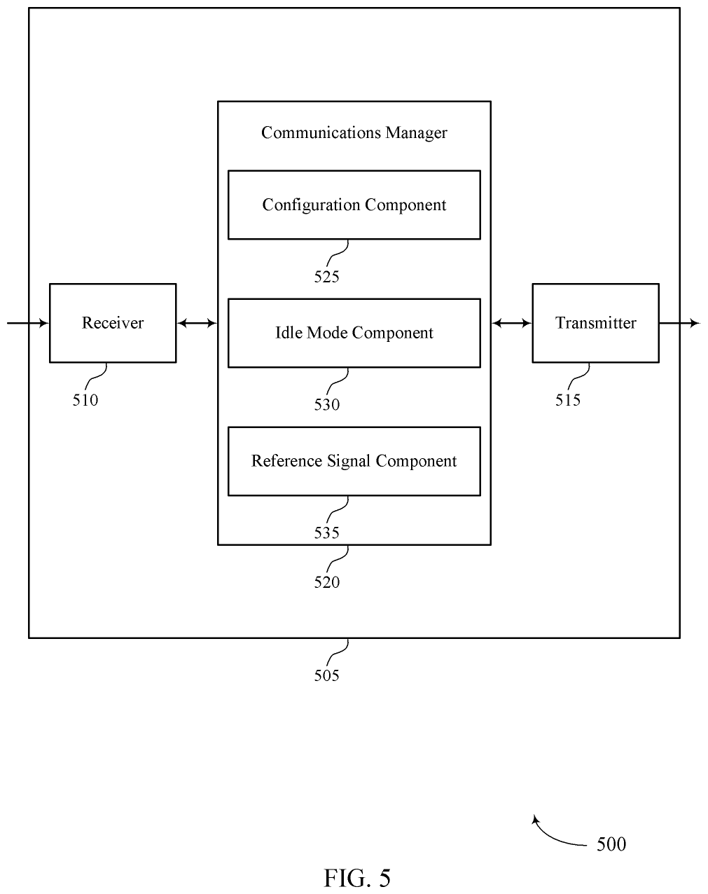

FIG. 5 shows a block diagram 500 of a device 505 that supports TRSs for energy saving modes in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to TRSs for energy saving modes). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to TRSs for energy saving modes). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of TRSs for energy saving modes as described herein. For example, the communications manager 520 may include a configuration component 525, an idle mode component 530, a reference signal component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. The configuration component 525 may be configured as or otherwise support a means for receiving, while in a connected mode, a control message indicating whether the UE is to use CSI-RSs for one or more functions, the one or more functions including using the CSI-RSs as TRSs when the UE operates in an idle mode or an inactive mode. The idle mode component 530 may be configured as or otherwise support a means for transitioning to the idle mode or the inactive mode. The reference signal component 535 may be configured as or otherwise support a means for performing, while in the idle mode or the inactive mode, AGC or time/frequency tracking, or both, using the CSI-RSs as the TRSs based on the control message indicating that the UE is to use the CSI-RSs for the one or more functions including using the CSI-RSs as the TRSs.

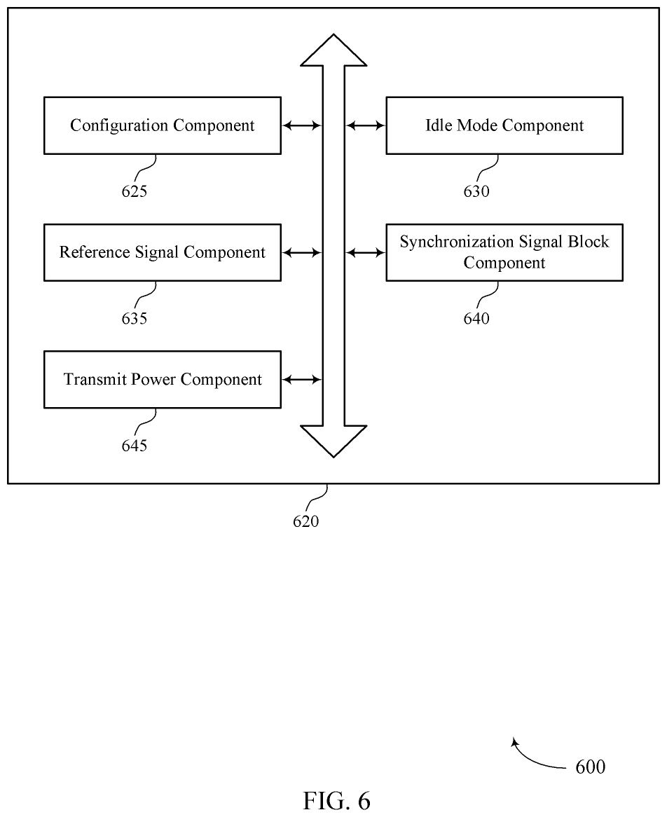

FIG. 6 shows a block diagram 600 of a communications manager 620 that supports TRSs for energy saving modes in accordance with one or more aspects of the present disclosure. The communications manager 620 may be an example of aspects of a communications manager 420, a communications manager 520, or both, as described herein. The communications manager 620, or various components thereof, may be an example of means for performing various aspects of TRSs for energy saving modes as described herein. For example, the communications manager 620 may include a configuration component 625, an idle mode component 630, a reference signal component 635, a synchronization signal block component 640, a transmit power component 645, or any combination thereof. Each of these components may communicate, directly or indirectly, with one another (e.g., via one or more buses).

The communications manager 620 may support wireless communication at a UE in accordance with examples as disclosed herein. The configuration component 625 may be configured as or otherwise support a means for receiving, while in a connected mode, a control message indicating whether the UE is to use CSI-RSs for one or more functions, the one or more functions including using the CSI-RSs as TRSs when the UE operates in an idle mode or an inactive mode. The idle mode component 630 may be configured as or otherwise support a means for transitioning to the idle mode or the inactive mode. The reference signal component 635 may be configured as or otherwise support a means for performing, while in the idle mode or the inactive mode, AGC or time/frequency tracking, or both, using the CSI-RSs as the TRSs based on the control message indicating that the UE is to use the CSI-RSs for the one or more functions including using the CSI-RSs as the TRSs.

In some examples, to support performing the AGC or the time/frequency tracking, or both, the reference signal component 635 may be configured as or otherwise support a means for performing the AGC or the time/frequency tracking, or both, using the CSI-RSs in accordance with the control message and based on one or more CSI-RS resource occasions associated with the CSI-RSs.

In some examples, the control message further indicates a first CSI-RS resource configuration for the one or more CSI-RS resource occasions, and the transmit power component 645 may be configured as or otherwise support a means for identifying one or more transmit power offsets between a CSI-RS transmit power and a synchronization signal block transmit power, the first CSI-RS resource configuration indicating the one or more transmit power offsets, where performing the AGC or the time/frequency tracking, or both, using the CSI-RSs is based on the one or more transmit power offsets.

In some examples, the one or more transmit power offsets include a respective transmit power offset for each CSI-RS resource occasion of the one or more CSI-RS resource occasions.

In some examples, the configuration component 625 may be configured as or otherwise support a means for receiving a control signal for paging message reception indicating a CSI-RS resource configuration for one or more other CSI-RS resource occasions that override the one or more CSI-RS resource occasions. In some examples, the reference signal component 635 may be configured as or otherwise support a means for performing additional AGC or additional time/frequency tracking, or both, using the CSI-RSs based on the one or more other CSI-RS resource occasions.

In some examples, the control signal for paging message reception includes an EPI or paging DCI.

In some examples, the configuration component 625 may be configured as or otherwise support a means for receiving a system information message indicating a first CSI-RS resource configuration, the first CSI-RS resource configuration being different from a prior CSI-RS resource configuration received by the UE and indicating the one or more CSI-RS resource occasions, where performing the AGC or the time/frequency tracking, or both, using the CSI-RSs is based on the first CSI-RS resource configuration.

In some examples, the system information message is received before transitioning to the idle mode or the inactive mode. In some examples, the system information message is received after transitioning to the idle mode or the inactive mode.

In some examples, the configuration component 625 may be configured as or otherwise support a means for receiving a control signal for paging message reception indicating a second CSI-RS resource configuration for one or more other CSI-RS resource occasions that override the one or more CSI-RS resource occasions. In some examples, the reference signal component 635 may be configured as or otherwise support a means for performing additional AGC or additional time/frequency tracking, or both, using the CSI-RSs based on the one or more other CSI-RS resource occasions.

In some examples, the control signal for paging message reception includes an EPI or paging DCI.

In some examples, the configuration component 625 may be configured as or otherwise support a means for receiving a system information message indicating a set of multiple CSI-RS resource configurations, where performing the AGC or the time/frequency tracking, or both, using the CSI-RSs is based on a first CSI-RS resource configuration of the set of multiple CSI-RS resource configurations, the first CSI-RS resource configuration indicating the one or more CSI-RS resource occasions.

In some examples, the control message further indicates the first CSI-RS resource configuration of the set of multiple CSI-RS resource configurations.

In some examples, the control message excludes an indication of a CSI-RS resource configuration of the set of multiple CSI-RS resource configurations, the first CSI-RS resource configuration including a default CSI-RS resource configuration.

In some examples, the configuration component 625 may be configured as or otherwise support a means for receiving a control signal for paging message reception indicating a second CSI-RS resource configuration of the set of multiple CSI-RS resource configurations, the second CSI-RS resource configuration being different from the first CSI-RS resource configuration. In some examples, the reference signal component 635 may be configured as or otherwise support a means for performing additional AGC or additional time/frequency tracking, or both, using the CSI-RSs based on the second CSI-RS resource configuration.

In some examples, the control signal for paging message reception includes an EPI or paging DCI.

In some examples, the configuration component 625 may be configured as or otherwise support a means for receiving a second control message indicating that the UE is to exclude the CSI-RSs for the one or more functions including using the CSI-RSs as the TRSs, and where performing the AGC or the time/frequency tracking, or both, includes. In some examples, the synchronization signal block component 640 may be configured as or otherwise support a means for performing the AGC or the time/frequency tracking, or both, using synchronization signal blocks in accordance with the second control message.

In some examples, the configuration component 625 may be configured as or otherwise support a means for receiving, before transitioning to the idle mode or the inactive mode, a configuration of one or more functions that are associated with dynamic adaptation of one or more communication parameters, where the AGC or the time/frequency tracking, or both, are performed using the CSI-RSs based on the configuration of the one or more functions.

In some examples, the control message includes an RRC message or MAC-CE message.

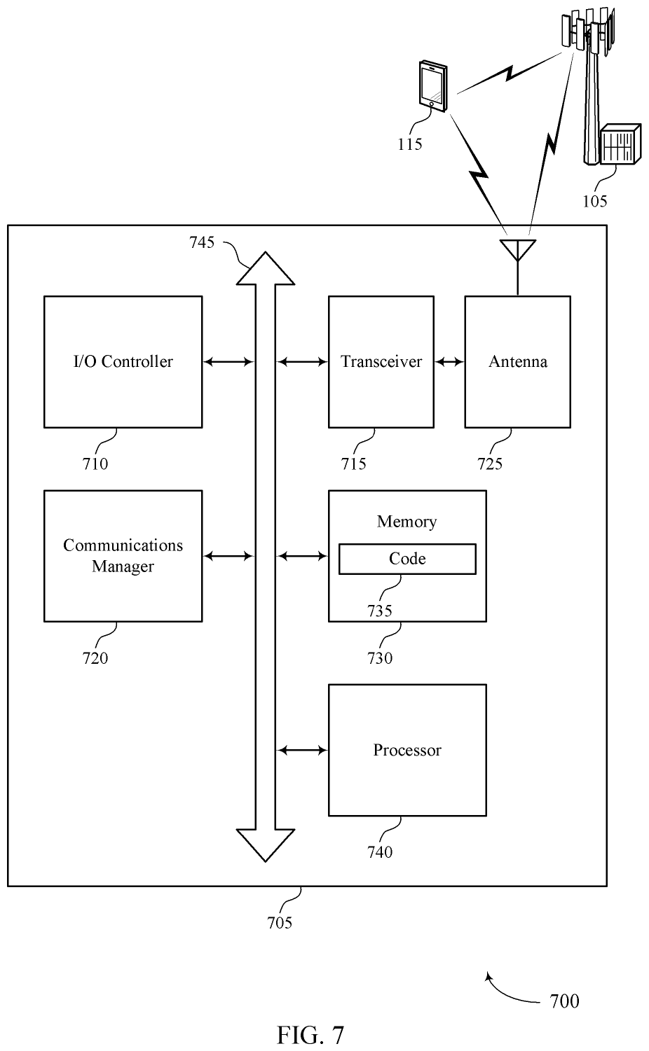

FIG. 7 shows a diagram of a system 700 including a device 705 that supports TRSs for energy saving modes in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting TRSs for energy saving modes). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving, while in a connected mode, a control message indicating whether the UE is to use CSI-RSs for one or more functions, the one or more functions including using the CSI-RSs as TRSs when the UE operates in an idle mode or an inactive mode. The communications manager 720 may be configured as or otherwise support a means for transitioning to the idle mode or the inactive mode. The communications manager 720 may be configured as or otherwise support a means for performing, while in the idle mode or the inactive mode, AGC or time/frequency tracking, or both, using the CSI-RSs as the TRSs based on the control message indicating that the UE is to use the CSI-RSs for the one or more functions including using the CSI-RSs as the TRSs.

By including or configuring the communications manager 720 in accordance with examples as described herein, the device 705 may support techniques for TRSs for energy saving modes which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of TRSs for energy saving modes as described herein, or the processor 740 and the memory 730 may be otherwise configured to perform or support such operations.

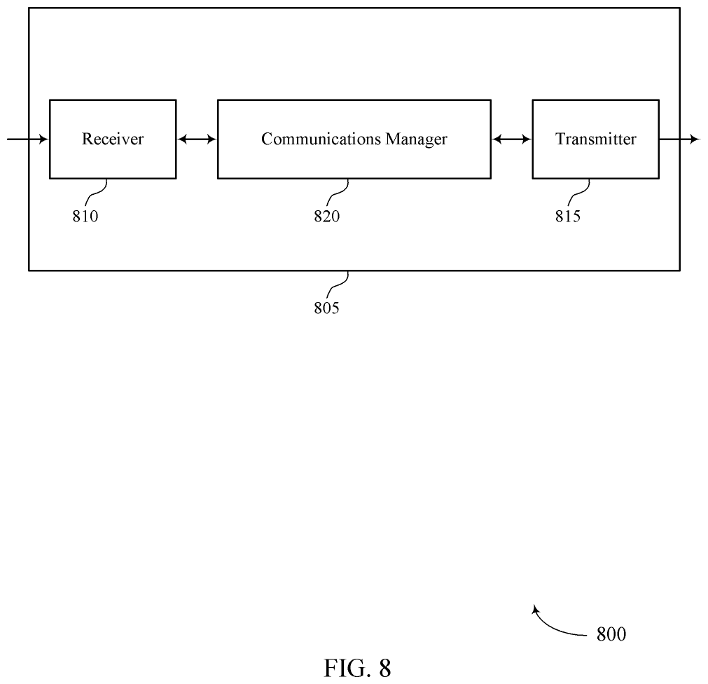

FIG. 8 shows a block diagram 800 of a device 805 that supports TRSs for energy saving modes in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of TRSs for energy saving modes as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. For example, the communications manager 820 may be configured as or otherwise support a means for communicating with a UE while the UE operates in a connected mode. The communications manager 820 may be configured as or otherwise support a means for transmitting, to the UE, a control message indicating whether the UE is to use CSI-RSs for one or more functions, the one or more functions including using the CSI-RSs as TRSs when the UE operates in an idle mode or an inactive mode. The communications manager 820 may be configured as or otherwise support a means for transmitting the CSI-RSs while the UE is in the idle mode or the inactive mode, where the CSI-RSs are transmitted based on a dynamic adaptation of one or more communication parameters that modify a transmit power of the CSI-RSs.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for TRSs for energy saving modes which may result in reduced processing, reduced power consumption, and more efficient utilization of communication resources, among other advantages.

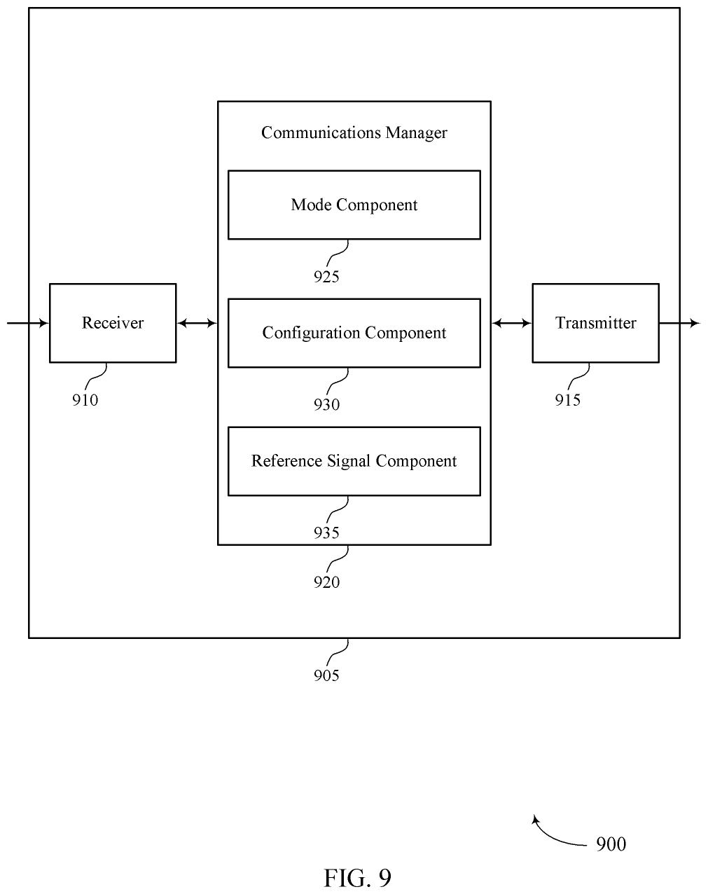

FIG. 9 shows a block diagram 900 of a device 905 that supports TRSs for energy saving modes in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of TRSs for energy saving modes as described herein. For example, the communications manager 920 may include a mode component 925, a configuration component 930, a reference signal component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. The mode component 925 may be configured as or otherwise support a means for communicating with a UE while the UE operates in a connected mode. The configuration component 930 may be configured as or otherwise support a means for transmitting, to the UE, a control message indicating whether the UE is to use CSI-RSs for one or more functions, the one or more functions including using the CSI-RSs as TRSs when the UE operates in an idle mode or an inactive mode. The reference signal component 935 may be configured as or otherwise support a means for transmitting the CSI-RSs while the UE is in the idle mode or the inactive mode, where the CSI-RSs are transmitted based on a dynamic adaptation of one or more communication parameters that modify a transmit power of the CSI-RSs.

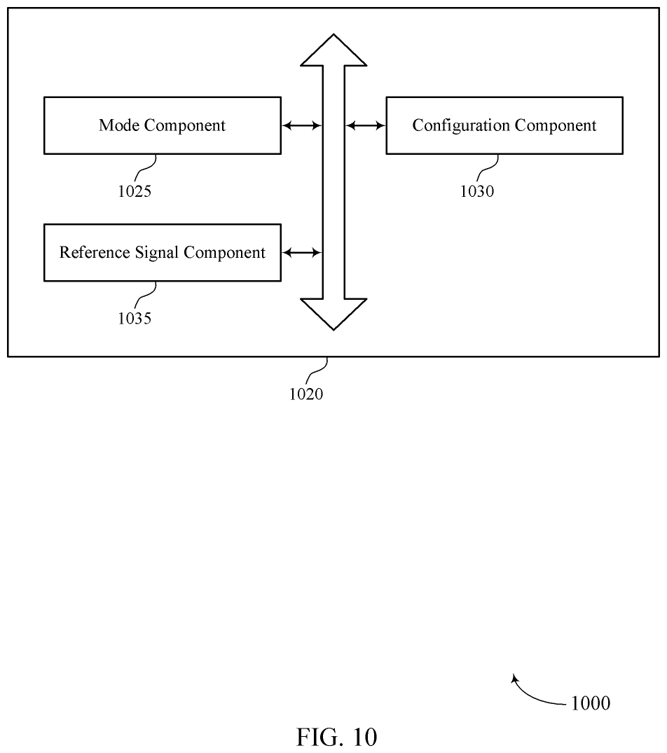

FIG. 10 shows a block diagram 1000 of a communications manager 1020 that supports TRSs for energy saving modes in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of TRSs for energy saving modes as described herein. For example, the communications manager 1020 may include a mode component 1025, a configuration component 1030, a reference signal component 1035, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The mode component 1025 may be configured as or otherwise support a means for communicating with a UE while the UE operates in a connected mode. The configuration component 1030 may be configured as or otherwise support a means for transmitting, to the UE, a control message indicating whether the UE is to use CSI-RSs for one or more functions, the one or more functions including using the CSI-RSs as TRSs when the UE operates in an idle mode or an inactive mode. The reference signal component 1035 may be configured as or otherwise support a means for transmitting the CSI-RSs while the UE is in the idle mode or the inactive mode, where the CSI-RSs are transmitted based on a dynamic adaptation of one or more communication parameters that modify a transmit power of the CSI-RSs.

In some examples, to support transmitting the control message, the configuration component 1030 may be configured as or otherwise support a means for transmitting the control message including an indication that the UE is to use the CSI-RSs for the one or more functions including using the CSI-RSs as the TRSs.

In some examples, the control message further indicates a first CSI-RS resource configuration for one or more CSI-RS resource occasions associated with the CSI-RSs, the first CSI-RS resource configuration indicating one or more transmit power offsets between a CSI-RS transmit power and a synchronization signal block transmit power. In some examples, the one or more transmit power offsets include a respective transmit power offset for each CSI-RS resource occasion of the one or more CSI-RS resource occasions.

In some examples, the configuration component 1030 may be configured as or otherwise support a means for transmitting a control signal for paging message reception indicating a second CSI-RS resource configuration for one or more other CSI-RS resource occasions that override the one or more CSI-RS resource occasions, where the control signal for paging message reception includes an EPI or paging DCI.

In some examples, the configuration component 1030 may be configured as or otherwise support a means for transmitting a system information message indicating a first CSI-RS resource configuration for one or more CSI-RS resource occasions associated with the CSI-RSs, the first CSI-RS resource configuration being different from a prior CSI-RS resource configuration transmitted to the UE, where the system information message is transmitted before the UE transitions to the idle mode or the inactive mode or after the UE transitions to the idle mode or the inactive mode.

In some examples, the configuration component 1030 may be configured as or otherwise support a means for transmitting a control signal for paging message reception indicating a second CSI-RS resource configuration for one or more other CSI-RS resource occasions that override the one or more CSI-RS resource occasions, where the control signal for paging message reception includes an EPI or paging DCI.

In some examples, the configuration component 1030 may be configured as or otherwise support a means for transmitting a system information message indicating a set of multiple CSI-RS resource configurations, where the control message indicates a first CSI-RS resource configuration of the set of multiple CSI-RS resource configurations, and where the first CSI-RS resource configuration is for one or more CSI-RS resource occasions associated with the CSI-RSs.

In some examples, the configuration component 1030 may be configured as or otherwise support a means for transmitting a control signal for paging message reception indicating a second CSI-RS resource configuration of the set of multiple CSI-RS resource configurations, the second CSI-RS resource configuration being different from the first CSI-RS resource configuration, where the control signal for paging message reception includes an EPI or paging DCI.

In some examples, to support transmitting the control message, the configuration component 1030 may be configured as or otherwise support a means for transmitting the control message including an indication that the UE is to exclude the CSI-RSs as the TRSs.

In some examples, the configuration component 1030 may be configured as or otherwise support a means for transmitting, before the UE transitions to the idle mode or the inactive mode, a configuration of one or more functions that are associated with the dynamic adaptation of the one or more communication parameters, where transmitting the control message indicating whether the UE is to use the CSI-RSs as the TRSs when the UE operates in an idle mode or an inactive mode is based on the configuration of the one or more functions.

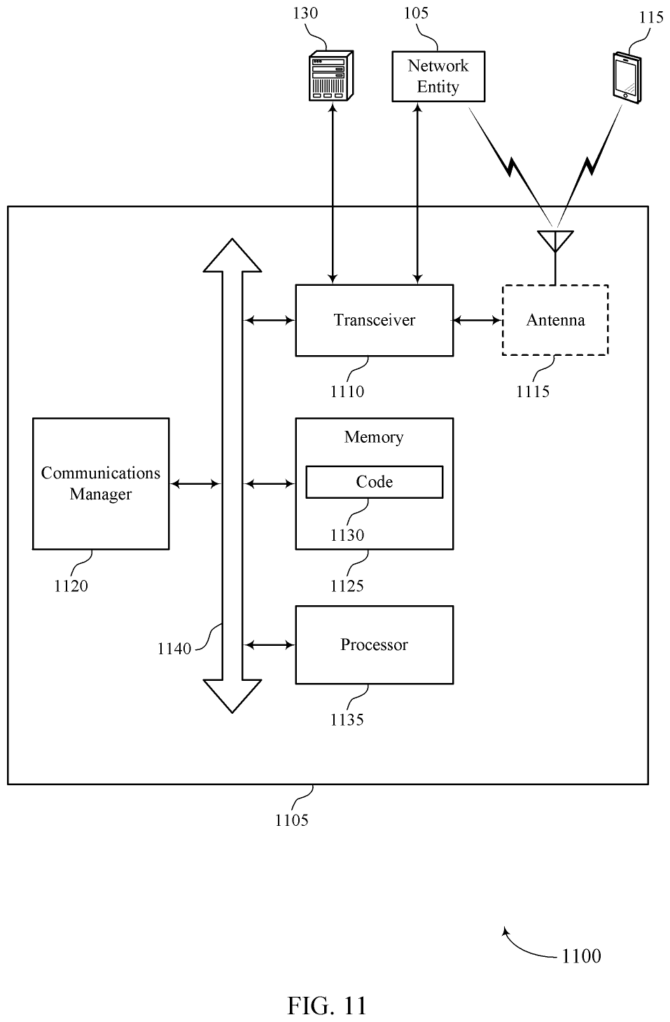

FIG. 11 shows a diagram of a system 1100 including a device 1105 that supports TRSs for energy saving modes in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting TRSs for energy saving modes). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity in accordance with examples as disclosed herein. For example, the communications manager 1120 may be configured as or otherwise support a means for communicating with a UE while the UE operates in a connected mode. The communications manager 1120 may be configured as or otherwise support a means for transmitting, to the UE, a control message indicating whether the UE is to use CSI-RSs for one or more functions, the one or more functions including using the CSI-RSs as TRSs when the UE operates in an idle mode or an inactive mode. The communications manager 1120 may be configured as or otherwise support a means for transmitting the CSI-RSs while the UE is in the idle mode or the inactive mode, where the CSI-RSs are transmitted based on a dynamic adaptation of one or more communication parameters that modify a transmit power of the CSI-RSs.

By including or configuring the communications manager 1120 in accordance with examples as described herein, the device 1105 may support techniques for TRSs for energy saving modes which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of TRSs for energy saving modes as described herein, or the processor 1135 and the memory 1125 may be otherwise configured to perform or support such operations.

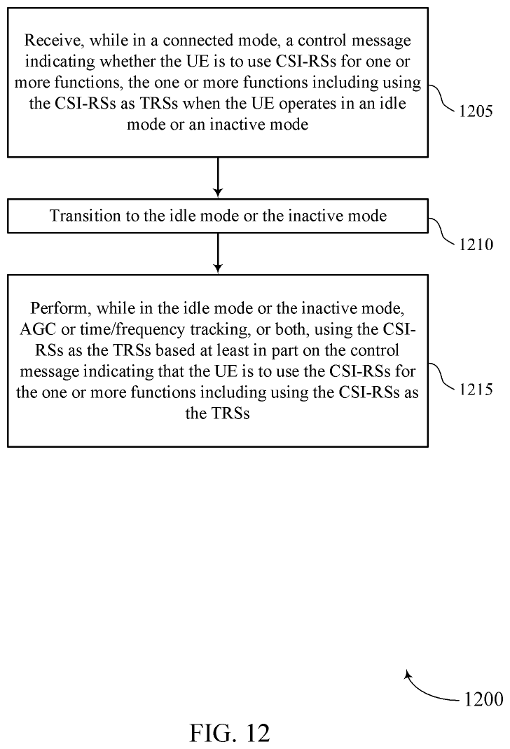

FIG. 12 illustrates a flowchart showing a method 1200 that supports TRSs for energy saving modes in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, while in a connected mode, a control message indicating whether the UE is to use CSI-RSs for one or more functions, the one or more functions including using the CSI-RSs as TRSs when the UE operates in an idle mode or an inactive mode. The operations of 1205 may be performed in accordance with examples as disclosed herein. In some examples, aspects of the operations of 1205 may be performed by a configuration component 625 as described with reference to FIG. 6.

At 1210, the method may include transitioning to the idle mode or the inactive mode. The operations of 1210 may be performed in accordance with examples as disclosed herein. In some examples, aspects of the operations of 1210 may be performed by an idle mode component 630 as described with reference to FIG. 6.

At 1215, the method may include performing, while in the idle mode or the inactive mode, AGC or time/frequency tracking, or both, using the CSI-RSs as the TRSs based on the control message indicating that the UE is to use the CSI-RSs for the one or more functions including using the CSI-RSs as the TRSs. The operations of 1215 may be performed in accordance with examples as disclosed herein. In some examples, aspects of the operations of 1215 may be performed by a reference signal component 635 as described with reference to FIG. 6.

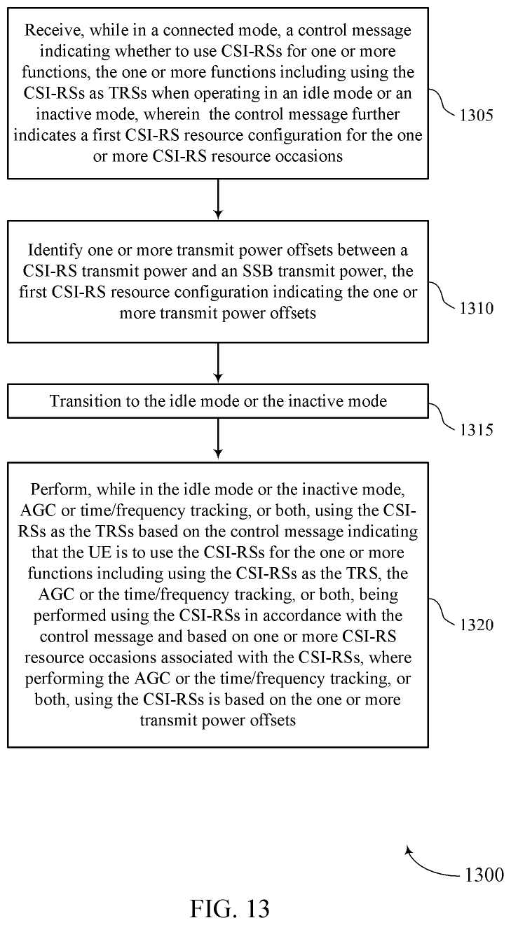

FIG. 13 illustrates a flowchart showing a method 1300 that supports tracking reference signals for energy saving modes in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, while in a connected mode, a control message indicating whether the UE is to use CSI-RSs for one or more functions, the one or more functions including using the CSI-RSs as TRSs when the UE operates in an idle mode or an inactive mode. In some examples, the control message may further indicate a first CSI-RS resource configuration for the one or more CSI-RS resource occasions. The operations of 1305 may be performed in accordance with examples as disclosed herein. In some examples, aspects of the operations of 1305 may be performed by a configuration component 625 as described with reference to FIG. 6.

At 1310, the method may include identifying one or more transmit power offsets between a CSI-RS transmit power and a synchronization signal block transmit power, the first CSI-RS resource configuration indicating the one or more transmit power offsets. The operations of 1310 may be performed in accordance with examples as disclosed herein. In some examples, aspects of the operations of 1310 may be performed by a transmit power component 645 as described with reference to FIG. 6.

At 1315, the method may include transitioning to the idle mode or the inactive mode. The operations of 1315 may be performed in accordance with examples as disclosed herein. In some examples, aspects of the operations of 1315 may be performed by an idle mode component 630 as described with reference to FIG. 6.

At 1320, the method may include performing, while in the idle mode or the inactive mode, AGC or time/frequency tracking, or both, using the CSI-RSs as the tracking reference signals based on the control message indicating that the UE is to use the CSI-RSs for the one or more functions including using the CSI-RSs as the tracking reference signals, the AGC or the time/frequency tracking, or both, being performed using the CSI-RSs in accordance with the control message and based on one or more CSI-RS resource occasions associated with the CSI-RSs. In some examples, performing the AGC or the time/frequency tracking, or both, using the CSI-RSs is based on the one or more transmit power offsets. The operations of 1320 may be performed in accordance with examples as disclosed herein. In some examples, aspects of the operations of 1320 may be performed by a reference signal component 635 as described with reference to FIG. 6.

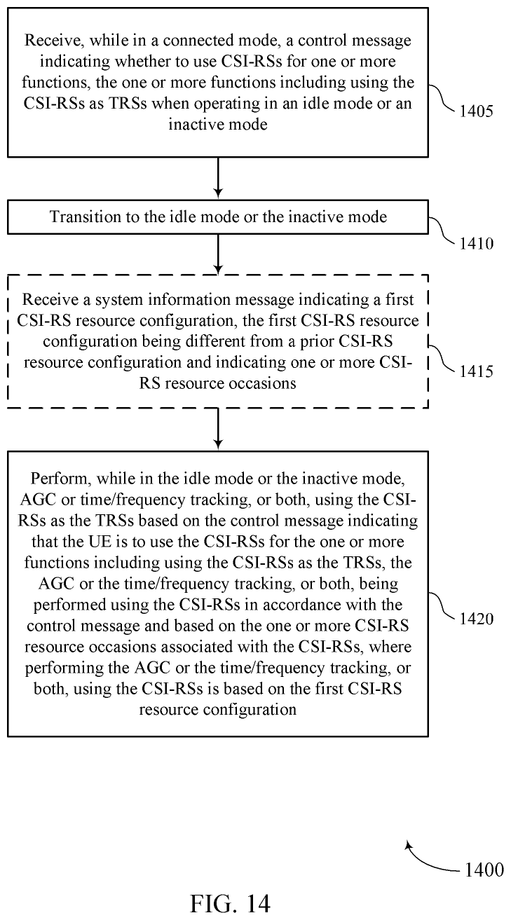

FIG. 14 illustrates a flowchart showing a method 1400 that supports tracking reference signals for energy saving modes in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving, while in a connected mode, a control message indicating whether the UE is to use CSI reference signals (CSI-RSs) for one or more functions, the one or more functions including using the CSI-RSs as tracking reference signals when the UE operates in an idle mode or an inactive mode. The operations of 1405 may be performed in accordance with examples as disclosed herein. In some examples, aspects of the operations of 1405 may be performed by a configuration component 625 as described with reference to FIG. 6.

At 1410, the method may include transitioning to the idle mode or the inactive mode. The operations of 1410 may be performed in accordance with examples as disclosed herein. In some examples, aspects of the operations of 1410 may be performed by an idle mode component 630 as described with reference to FIG. 6.

At 1415, the method may optionally include receiving a system information message indicating a first CSI-RS resource configuration, the first CSI-RS resource configuration being different from a prior CSI-RS resource configuration received by the UE and indicating the one or more CSI-RS resource occasions. In some examples, the system information message indicating the first resource configuration may be received before the UE transitions to the idle mode or the inactive mode. The operations of 1415 may be performed in accordance with examples as disclosed herein. In some examples, aspects of the operations of 1415 may be performed by a configuration component 625 as described with reference to FIG. 6.

At 1420, the method may include performing, while in the idle mode or the inactive mode, AGC or time/frequency tracking, or both, using the CSI-RSs as the tracking reference signals based on the control message indicating that the UE is to use the CSI-RSs for the one or more functions including using the CSI-RSs as the tracking reference signals, the AGC or the time/frequency tracking, or both, being performed using the CSI-RSs in accordance with the control message and based on one or more CSI-RS resource occasions associated with the CSI-RSs, where performing the AGC or the time/frequency tracking, or both, using the CSI-RSs is based on the first CSI-RS resource configuration. The operations of 1420 may be performed in accordance with examples as disclosed herein. In some examples, aspects of the operations of 1420 may be performed by a reference signal component 635 as described with reference to FIG. 6.

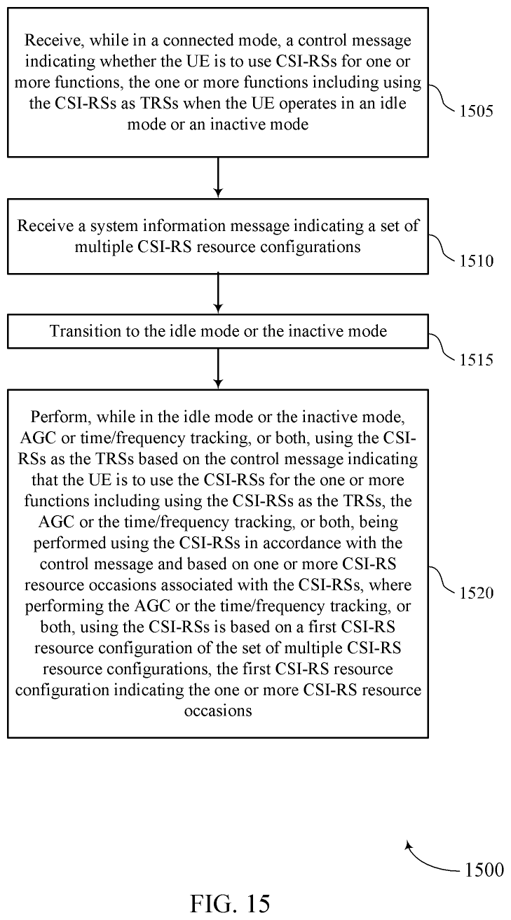

FIG. 15 illustrates a flowchart showing a method 1500 that supports tracking reference signals for energy saving modes in accordance with one or more aspects of the present disclosure. The operations of the method 1500 may be implemented by a UE or its components as described herein. For example, the operations of the method 1500 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1505, the method may include receiving, while in a connected mode, a control message indicating whether the UE is to use CSI reference signals (CSI-RSs) for one or more functions, the one or more functions including using the CSI-RSs as tracking reference signals when the UE operates in an idle mode or an inactive mode.

The operations of 1505 may be performed in accordance with examples as disclosed herein. In some examples, aspects of the operations of 1505 may be performed by a configuration component 625 as described with reference to FIG. 6.

At 1510, the method may include receiving a system information message indicating a set of multiple CSI-RS resource configurations. The operations of 1510 may be performed in accordance with examples as disclosed herein. In some examples, aspects of the operations of 1510 may be performed by a configuration component 625 as described with reference to FIG. 6.

At 1515, the method may include transitioning to the idle mode or the inactive mode. The operations of 1515 may be performed in accordance with examples as disclosed herein. In some examples, aspects of the operations of 1515 may be performed by an idle mode component 630 as described with reference to FIG. 6.

At 1520, the method may include performing. The operations of 1520 may be performed in accordance with examples as disclosed herein. In some examples, aspects of the operations of 1520 may be performed by a reference signal component 635 as described with reference to FIG. 6.

At 1525, the method may include performing, while in the idle mode or the inactive mode, AGC or time/frequency tracking, or both, using the CSI-RSs as the tracking reference signals based on the control message indicating that the UE is to use the CSI-RSs for the one or more functions including using the CSI-RSs as the tracking reference signals, the AGC or the time/frequency tracking, or both, being performed using the CSI-RSs in accordance with the control message and based on one or more CSI-RS resource occasions associated with the CSI-RSs. In some examples, performing the AGC or the time/frequency tracking, or both, using the CSI-RSs is based on a first CSI-RS resource configuration of the set of multiple CSI-RS resource configurations, the first CSI-RS resource configuration indicating the one or more CSI-RS resource occasions. The operations of 1525 may be performed in accordance with examples as disclosed herein. In some examples, aspects of the operations of 1525 may be performed by a reference signal component 635 as described with reference to FIG. 6.

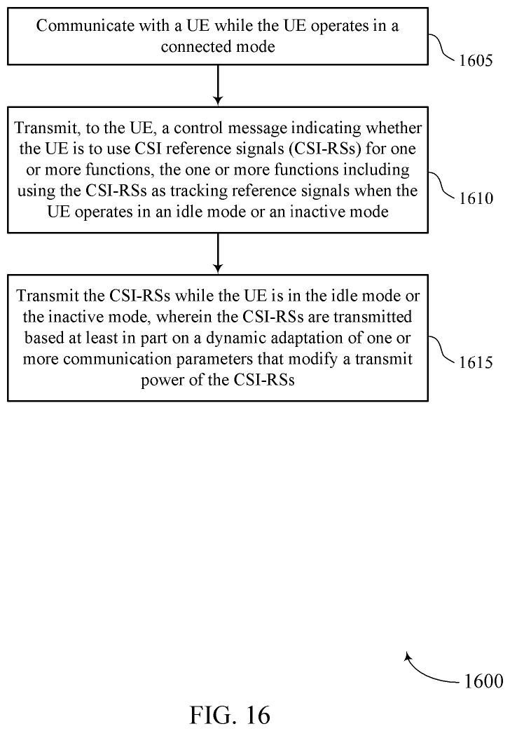

FIG. 16 illustrates a flowchart showing a method 1600 that supports tracking reference signals for energy saving modes in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include communicating with a UE while the UE operates in a connected mode. The operations of 1605 may be performed in accordance with examples as disclosed herein. In some examples, aspects of the operations of 1605 may be performed by a mode component 1025 as described with reference to FIG. 10.

At 1610, the method may include transmitting, to the UE, a control message indicating whether the UE is to use CSI reference signals (CSI-RSs) for one or more functions, the one or more functions including using the CSI-RSs as tracking reference signals when the UE operates in an idle mode or an inactive mode. The operations of 1610 may be performed in accordance with examples as disclosed herein. In some examples, aspects of the operations of 1610 may be performed by a configuration component 1030 as described with reference to FIG. 10.

At 1615, the method may include transmitting the CSI-RSs while the UE is in the idle mode or the inactive mode, where the CSI-RSs are transmitted based on a dynamic adaptation of one or more communication parameters that modify a transmit power of the CSI-RSs. The operations of 1615 may be performed in accordance with examples as disclosed herein. In some examples, aspects of the operations of 1615 may be performed by a reference signal component 1035 as described with reference to FIG. 10.

The following provides an overview of aspects of the present disclosure:

Aspect 1: A method for wireless communication at a UE, comprising: receiving, while in a connected mode, a control message indicating whether the UE is to use CSI-RSs for one or more functions, the one or more functions including using the CSI-RSs as TRSs when the UE operates in an idle mode or an inactive mode; transitioning to the idle mode or the inactive mode; and performing, while in the idle mode or the inactive mode, AGC or time/frequency tracking, or both, using the CSI-RSs as the TRSs based at least in part on the control message indicating that the UE is to use the CSI-RSs for the one or more functions including using the CSI-RSs as the TRSs.

Aspect 2: The method of aspect 1, wherein performing the AGC or the time/frequency tracking, or both, comprises: performing the AGC or the time/frequency tracking, or both, using the CSI-RSs in accordance with the control message and based at least in part on one or more CSI-RS resource occasions associated with the CSI-RSs.

Aspect 3: The method of aspect 2, wherein the control message further indicates a first CSI-RS resource configuration for the one or more CSI-RS resource occasions, the method further comprising: identifying one or more transmit power offsets between a CSI-RS transmit power and a SSB transmit power, the first CSI-RS resource configuration indicating the one or more transmit power offsets, wherein performing the AGC or the time/frequency tracking, or both, using the CSI-RSs is based at least in part on the one or more transmit power offsets.

Aspect 4: The method of aspect 3, wherein the one or more transmit power offsets comprise a respective transmit power offset for each CSI-RS resource occasion of the one or more CSI-RS resource occasions.

Aspect 5: The method of any of aspects 3 through 4, further comprising: receiving a control signal for paging message reception indicating a CSI-RS resource configuration for one or more other CSI-RS resource occasions that override the one or more CSI-RS resource occasions; and performing additional AGC or additional time/frequency tracking, or both, using the CSI-RSs based at least in part on the one or more other CSI-RS resource occasions.

Aspect 6: The method of aspect 5, wherein the control signal for paging message reception comprises an EPI or paging DCI.

Aspect 7: The method of aspect 2, further comprising: receiving a system information message indicating a first CSI-RS resource configuration, the first CSI-RS resource configuration being different from a prior CSI-RS resource configuration received by the UE and indicating the one or more CSI-RS resource occasions, wherein performing the AGC or the time/frequency tracking, or both, using the CSI-RSs is based at least in part on the first CSI-RS resource configuration.

Aspect 8: The method of aspect 7, wherein the system information message is received before transitioning to the idle mode or the inactive mode; or the system information message is received after transitioning to the idle mode or the inactive mode.

Aspect 9: The method of any of aspects 7 through 8, further comprising: receiving a control signal for paging message reception indicating a second CSI-RS resource configuration for one or more other CSI-RS resource occasions that override the one or more CSI-RS resource occasions; and performing additional AGC or additional time/frequency tracking, or both, using the CSI-RSs based at least in part on the one or more other CSI-RS resource occasions.

Aspect 10: The method of aspect 9, wherein the control signal for paging message reception comprises an EPI or paging DCI.

Aspect 11: The method of aspect 2, further comprising: receiving a system information message indicating a plurality of CSI-RS resource configurations, wherein performing the AGC or the time/frequency tracking, or both, using the CSI-RSs is based at least in part on a first CSI-RS resource configuration of the plurality of CSI-RS resource configurations, the first CSI-RS resource configuration indicating the one or more CSI-RS resource occasions.

Aspect 12: The method of aspect 11, wherein the control message further indicates the first CSI-RS resource configuration of the plurality of CSI-RS resource configurations.

Aspect 13: The method of any of aspects 11 through 12, wherein the control message excludes an indication of a CSI-RS resource configuration of the plurality of CSI-RS resource configurations, the first CSI-RS resource configuration comprising a default CSI-RS resource configuration.

Aspect 14: The method of any of aspects 11 through 13, further comprising: receiving a control signal for paging message reception indicating a second CSI-RS resource configuration of the plurality of CSI-RS resource configurations, the second CSI-RS resource configuration being different from the first CSI-RS resource configuration; and performing additional AGC or additional time/frequency tracking, or both, using the CSI-RSs based at least in part on the second CSI-RS resource configuration.

Aspect 15: The method of aspect 14, wherein the control signal for paging message reception comprises an EPI or paging DCI.

Aspect 16: The method of any of aspects 1 through 15, further comprising: receiving a second control message indicating that the UE is to exclude the CSI-RSs for the one or more functions including using the CSI-RSs as the TRSs, and wherein performing the AGC or the time/frequency tracking, or both, comprises: performing the AGC or the time/frequency tracking, or both, using SSBs in accordance with the second control message.

Aspect 17: The method of any of aspects 1 through 16, further comprising: receiving, before transitioning to the idle mode or the inactive mode, a configuration of one or more functions that are associated with dynamic adaptation of one or more communication parameters, wherein the AGC or the time/frequency tracking, or both, are performed using the CSI-RSs based at least in part on the configuration of the one or more functions.

Aspect 18: The method of any of aspects 1 through 17, wherein the control message comprises an RRC message or MAC-CE message.

Aspect 19: A method for wireless communication at a network entity, comprising: communicating with a UE while the UE operates in a connected mode; transmitting, to the UE, a control message indicating whether the UE is to use CSI-RSs for one or more functions, the one or more functions including using the CSI-RSs as TRSs when the UE operates in an idle mode or an inactive mode; and transmitting the CSI-RSs while the UE is in the idle mode or the inactive mode, wherein the CSI-RSs are transmitted based at least in part on a dynamic adaptation of one or more communication parameters that modify a transmit power of the CSI-RSs.

Aspect 20: The method of aspect 19, wherein transmitting the control message comprises: transmitting the control message including an indication that the UE is to use the CSI-RSs for the one or more functions including using the CSI-RSs as the TRSs.

Aspect 21: The method of aspect 20, wherein the control message further indicates a first CSI-RS resource configuration for one or more CSI-RS resource occasions associated with the CSI-RSs, the first CSI-RS resource configuration indicating one or more transmit power offsets between a CSI-RS transmit power and a SSB transmit power, the one or more transmit power offsets comprise a respective transmit power offset for each CSI-RS resource occasion of the one or more CSI-RS resource occasions.

Aspect 22: The method of aspect 21, further comprising: transmitting a control signal for paging message reception indicating a second CSI-RS resource configuration for one or more other CSI-RS resource occasions that override the one or more CSI-RS resource occasions, wherein the control signal for paging message reception comprises an EPI or paging DCI.

Aspect 23: The method of aspect 20, further comprising: transmitting a system information message indicating a first CSI-RS resource configuration for one or more CSI-RS resource occasions associated with the CSI-RSs, the first CSI-RS resource configuration being different from a prior CSI-RS resource configuration transmitted to the UE, wherein the system information message is transmitted before the UE transitions to the idle mode or the inactive mode or after the UE transitions to the idle mode or the inactive mode.

Aspect 24: The method of aspect 23, further comprising: transmitting a control signal for paging message reception indicating a second CSI-RS resource configuration for one or more other CSI-RS resource occasions that override the one or more CSI-RS resource occasions, wherein the control signal for paging message reception comprises an EPI or paging DCI.

Aspect 25: The method of aspect 20, further comprising: transmitting a system information message indicating a plurality of CSI-RS resource configurations, wherein the control message indicates a first CSI-RS resource configuration of the plurality of CSI-RS resource configurations, and wherein the first CSI-RS resource configuration is for one or more CSI-RS resource occasions associated with the CSI-RSs.

Aspect 26: The method of aspect 25, further comprising: transmitting a control signal for paging message reception indicating a second CSI-RS resource configuration of the plurality of CSI-RS resource configurations, the second CSI-RS resource configuration being different from the first CSI-RS resource configuration, wherein the control signal for paging message reception comprises an EPI or paging DCI.

Aspect 27: The method of any of aspects 19 through 26, wherein transmitting the control message comprises: transmitting the control message including an indication that the UE is to exclude the CSI-RSs as the TRSs.

Aspect 28: The method of any of aspects 19 through 27, further comprising: transmitting, before the UE transitions to the idle mode or the inactive mode, a configuration of one or more functions that are associated with the dynamic adaptation of the one or more communication parameters, wherein transmitting the control message indicating whether the UE is to use the CSI-RSs as the TRSs when the UE operates in an idle mode or an inactive mode is based at least in part on the configuration of the one or more functions.

Aspect 29: An apparatus for wireless communication at a UE, comprising a processor; memory coupled with the processor; and instructions stored in the memory and executable by the processor to cause the apparatus to perform a method of any of aspects 1 through 18.

Aspect 30: An apparatus for wireless communication at a UE, comprising at least one means for performing a method of any of aspects 1 through 18.

Aspect 31: A non-transitory computer-readable medium storing code for wireless communication at a UE, the code comprising instructions executable by a processor to perform a method of any of aspects 1 through 18.

Aspect 32: An apparatus for wireless communication at a network entity, comprising a processor; memory coupled with the processor; and instructions stored in the memory and executable by the processor to cause the apparatus to perform a method of any of aspects 19 through 28.

Aspect 33: An apparatus for wireless communication at a network entity, comprising at least one means for performing a method of any of aspects 19 through 28.

Aspect 34: A non-transitory computer-readable medium storing code for wireless communication at a network entity, the code comprising instructions executable by a processor to perform a method of any of aspects 19 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a memory; and
a processor coupled to the memory and configured to:
receive, while in a connected mode, a control message indicating whether the UE is to use channel state information (CSI) reference signals (CSI-RSs) for one or more functions, the one or more functions including using the CSI-RSs as tracking reference signals when the UE operates in an idle mode or an inactive mode;
transition to the idle mode or the inactive mode; and
perform, while in the idle mode or the inactive mode, automatic gain control or time/frequency tracking, or both, using the CSI-RSs as the tracking reference signals based at least in part on the control message indicating that the UE is to use the CSI-RSs for the one or more functions including using the CSI-RSs as the tracking reference signals.

2. The apparatus of claim 1, wherein, to perform the automatic gain control or the time/frequency tracking, or both, the processor is further configured to:
perform the automatic gain control or the time/frequency tracking, or both, using the CSI-RSs in accordance with the control message and based at least in part on one or more CSI-RS resource occasions associated with the CSI-RSs.

3. The apparatus of claim 2, wherein the control message further indicates a first CSI-RS resource configuration for the one or more CSI-RS resource occasions, and the processor is further configured to:
identify one or more transmit power offsets between a CSI-RS transmit power and a synchronization signal block transmit power, the first CSI-RS resource configuration indicating the one or more transmit power offsets, wherein performing the automatic gain control or the time/frequency tracking, or both, using the CSI-RSs is based at least in part on the one or more transmit power offsets.

4. The apparatus of claim 3, wherein the one or more transmit power offsets comprise a respective transmit power offset for each CSI-RS resource occasion of the one or more CSI-RS resource occasions.

5. The apparatus of claim 3, wherein the processor is further configured to:
receive a control signal for paging message reception indicating a CSI-RS resource configuration for one or more other CSI-RS resource occasions that override the one or more CSI-RS resource occasions; and
perform additional automatic gain control or additional time/frequency tracking, or both, using the CSI-RSs based at least in part on the one or more other CSI-RS resource occasions.

6. The apparatus of claim 5, wherein the control signal for paging message reception comprises an early paging indication or paging downlink control information.

7. The apparatus of claim 2, wherein the processor is further configured to:
receive a system information message indicating a first CSI-RS resource configuration, the first CSI-RS resource configuration being different from a prior CSI-RS resource configuration received by the UE and indicating the one or more CSI-RS resource occasions, wherein performing the automatic gain control or the time/frequency tracking, or both, using the CSI-RSs is based at least in part on the first CSI-RS resource configuration.

8. (canceled)

9. The apparatus of claim 7, wherein the processor is further configured to:
receive a control signal for paging message reception indicating a second CSI-RS resource configuration for one or more other CSI-RS resource occasions that override the one or more CSI-RS resource occasions; and
perform additional automatic gain control or additional time/frequency tracking, or both, using the CSI-RSs based at least in part on the one or more other CSI-RS resource occasions.

10. The apparatus of claim 9, wherein the control signal for paging message reception comprises an early paging indication or paging downlink control information.

11. The apparatus of claim 2, wherein the processor is further configured to:
receive a system information message indicating a plurality of CSI-RS resource configurations, wherein performing the automatic gain control or the time/frequency tracking, or both, using the CSI-RSs is based at least in part on a first CSI-RS resource configuration of the plurality of CSI-RS resource configurations, the first CSI-RS resource configuration indicating the one or more CSI-RS resource occasions.

12. (canceled)

13. The apparatus of claim 11, wherein the control message excludes an indication of a CSI-RS resource configuration of the plurality of CSI-RS resource configurations, the first CSI-RS resource configuration comprising a default CSI-RS resource configuration.

14. The apparatus of claim 11, wherein the processor is further configured to:
receive a control signal for paging message reception indicating a second CSI-RS resource configuration of the plurality of CSI-RS resource configurations, the second CSI-RS resource configuration being different from the first CSI-RS resource configuration; and
perform additional automatic gain control or additional time/frequency tracking, or both, using the CSI-RSs based at least in part on the second CSI-RS resource configuration.

15. The apparatus of claim 14, wherein the control signal for paging message reception comprises an early paging indication or paging downlink control information.

16. The apparatus of claim 1, wherein the processor is further configured to:
receive a second control message indicating that the UE is to exclude the CSI-RSs for the one or more functions including using the CSI-RSs as the tracking reference signals, and wherein performing the automatic gain control or the time/frequency tracking, or both, comprises:
perform the automatic gain control or the time/frequency tracking, or both, using synchronization signal blocks in accordance with the second control message.

17. The apparatus of claim 1, wherein the processor is further configured to:
receive, before transitioning to the idle mode or the inactive mode, a configuration of one or more functions that are associated with dynamic adaptation of one or more communication parameters, wherein the automatic gain control or the time/frequency tracking, or both, are performed using the CSI-RSs based at least in part on the configuration of the one or more functions.

18. The apparatus of claim 1, wherein the control message comprises a radio resource control (RRC) message or medium access control (MAC) control element (MAC-CE) message.

19-28. (canceled)

29. A method for wireless communication at a user equipment (UE), comprising:
receiving, while in a connected mode, a control message indicating whether the UE is to use channel state information (CSI) reference signals (CSI-RSs) for one or more functions, the one or more functions including using the CSI-RSs as tracking reference signals when the UE operates in an idle mode or an inactive mode;
transitioning to the idle mode or the inactive mode; and
performing, while in the idle mode or the inactive mode, automatic gain control or time/frequency tracking, or both, using the CSI-RSs as the tracking reference signals based at least in part on the control message indicating that the UE is to use the CSI-RSs for the one or more functions including using the CSI-RSs as the tracking reference signals.

30. A method for wireless communication at a network entity, comprising:
communicating with a user equipment (UE) while the UE operates in a connected mode; transmitting, to the UE, a control message indicating whether the UE is to use channel state information (CSI) reference signals (CSI-RSs) for one or more functions, the one or more functions including using the CSI-RSs as tracking reference signals when the UE operates in an idle mode or an inactive mode; and
transmitting the CSI-RSs while the UE is in the idle mode or the inactive mode, wherein the CSI-RSs are transmitted based at least in part on a dynamic adaptation of one or more communication parameters that modify a transmit power of the CSI-RSs.
